(19) United States
(12) Patent Application Publication
(10) Pub. No.: US 2021/0009161 A1
(43) Pub. Date: Jan. 14, 2021

(54) PATH PROVIDING DEVICE AND PATH PROVIDING METHOD THEREOF

(71) Applicant: LG Electronics Inc., Seoul (KR)

(72) Inventors: Jihyun KIM, Seoul (KR); Seunghwan BANG, Seoul (KR)

(21) Appl. No.: 17/036,877

(22) Filed: Sep. 29, 2020

Related U.S. Application Data
(63) Continuation of application No. PCT/KR2020/000460, filed on Jan. 10, 2020.
(60) Provisional application No. 62/850,561, filed on May 21, 2019.

(51) Int. Cl. B60W 60/00; B60W 30/12; B60W 40/06; H04W 4/44

(52) U.S. Cl. CPC B60W 60/0015; B60W 30/12; B60W 2556/40; H04W 4/44; B60W 2556/45; B60W 40/06

(57) ABSTRACT

A path providing device for a vehicle configured to communicate with a repeater includes: a telecommunication control unit configured to perform communication with the repeater, and a processor. The processor is configured to receive, from the repeater, EHP information comprising at least one of an optimal path providing a direction with respect to one or more lanes or autonomous driving visibility information in which sensing information is merged with the optimal path, and distribute the received EHP information to at least one electrical part disposed at the vehicle.

### CROSS-REFERENCE TO RELATED APPLICATIONS

This application is a continuation of International Application No. PCT/KR2020/000460, filed on Jan. 10, 2020, which claims the benefit of U.S. Provisional Application No. 62/850,561, filed on May 21, 2019. The disclosures of the prior applications are incorporated by reference in their entirety.

### TECHNICAL FIELD

The present disclosure relates to a path providing device providing a path (route) to a vehicle and a path providing method thereof.

### BACKGROUND

A vehicle refers to means of transporting people or goods by using kinetic energy. Representative examples of vehicles include automobiles and motorcycles.

For safety and convenience of a user who uses the vehicle, various sensors and devices are provided in the vehicle, and functions of the vehicle are diversified.

The functions of the vehicle may be divided into a convenience function for promoting driver's convenience, and a safety function for enhancing safety of the driver and/or pedestrians.

First, the convenience function has a development motive associated with the driver's convenience, such as providing infotainment (information+entertainment) to the vehicle, supporting a partially autonomous driving function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function is a technique of ensuring safeties of the driver and/or pedestrians, and may include various functions, such as a lane departure warning system (LDWS), a lane keeping assist system (LKAS), an autonomous emergency braking (AEB), and the like.

For the convenience of a user using a vehicle, various types of sensors and electronic devices are provided in the vehicle. Specifically, a study on an Advanced Driver Assistance System (ADAS) is actively undergoing. In addition, an autonomous vehicle is actively under development.

As the development of the advanced driver assistance system (ADAS) is actively undergoing in recent time, development of a technology for optimizing user's convenience and safety while driving a vehicle is required.

As part of this effort, in order to effectively transmit electronic Horizon (eHorizon) data to autonomous driving systems and infotainment systems, the European Union Original Equipment Manufacturing (EU OEM) Association has established a data specification and transmission method as a standard under the name “Advanced Driver Assistance Systems Interface Specification (ADASIS).”

In addition, eHorizon (software) is becoming an integral part of safety/ECO/convenience of autonomous vehicles in a connected environment.

### SUMMARY

The present disclosure describes a path providing device configured to provide field-of-view information for autonomous driving that enables autonomous driving, and a path providing method thereof.

The present disclosure also describes an optimized control method of a path providing device provided in a repeater.

The present disclosure further describes a path providing device capable of providing optimized information to a vehicle when the path providing device is provided in a repeater, and a path providing method thereof.

The present disclosure further describes a path providing device of a vehicle optimized to use EHP information provided by the path providing device provided in a repeater, and a path providing method thereof.

According to one aspect of the subject matter described in this application a path providing device for a vehicle configured to communicate with a repeater includes a telecommunication control unit configured to perform communication with the repeater, and a processor. The processor may be configured to receive, from the repeater, EHP information comprising at least one of an optimal path providing a direction with respect to one or more lanes or autonomous driving visibility information in which sensing information is merged with the optimal path, and distribute the received EHP information to at least one electrical part disposed at the vehicle.

Implementations according to this aspect may include one or more of the following features. For example, the processor may be configured to receive the EHP information generated by the repeater to change the received EHP information into a form that is usable in the at least one electrical part.

In some implementations, the processor may be configured to output an optimal path for guiding the vehicle in a lane among a plurality of lanes of a road or autonomously drive the vehicle based on the received EHP information. In some implementations, the processor may be configured to search for a new repeater based on the vehicle being sensed to leave an allocated area of the repeater in communication.

In some examples, the processor may be configured to receive, based on the new repeater being searched, receive EHP information from the new repeater, and receive, based on the new repeater not being searched, EHP information from a server through the telecommunication control unit. In some implementations, the telecommunication control unit may be configured to perform communication with a server, and the processor may be configured to receive first EHP information from a repeater and second EHP information from a server through the telecommunication control unit.

In some implementations, the processor may be configured to process the first EHP information and the second EHP information in a preset manner. In some examples, the processor may be configured to, based on the first EHP information and the second EHP information being the same, receive the first EHP information from the repeater, and stop receiving the second EHP information from the server.

In some examples, the processor may be configured to transmit different EHP information to an electrical part of the at least one electrical part according to a type of the electrical part based on the first EHP information and the second EHP information being different from each other. In some examples, the processor may be configured to autonomously drive the vehicle using at least one of the first EHP information or the second EHP information based on the first EHP information and the second EHP information being different from each other.

According to another aspect of the subject matter described in this application, a method for providing a path information to a vehicle, performed by the vehicle configured to communicate with a repeater, includes receiving, from the repeater, EHP information comprising at least one of an optimal path or autonomous driving visibility information in which sensing information is merged with the optimal path and distributing the received EHP information to at least one electrical part disposed at the vehicle.

Implementations according to this aspect may include one or more following features. For example, the method may further include receiving the EHP information generated by the repeater to change the received EHP information into a form that is usable in the at least one electrical part.

In some implementations, the method may further include outputting an optimal path for guiding the vehicle in a lane among a plurality of lanes of a road or autonomously drive the vehicle based on the received EHP information. In some implementations, the method may further include searching for a new repeater based on the vehicle being sensed to leave an allocated area of the repeater in communication.

In some examples, the method may further include receiving, based on the new repeater being searched, receive EHP information from the new repeater, and receiving, based on the new repeater not being searched, EHP information from a server. In some implementations, the method may further include receiving first EHP information from a repeater and second EHP information from a server.

In some examples, the method may further include processing the first EHP information and the second EHP information in a preset manner. In some examples, the method may further include based on the first EHP information and the second EHP information being the same, receiving the first EHP information from the repeater, and stop receiving the second EHP information from the server.

In some implementations, the method may further include transmitting different EHP information to an electrical part of the at least one electrical part according to a type of the electrical part based on the first EHP information and the second EHP information being different from each other. In some examples, the method may further include autonomously driving the vehicle using at least one of the first EHP information or the second EHP information based on the first EHP information and the second EHP information being different from each other.

The effects of a path providing device and a path providing method thereof according to the present disclosure will be described as follows.

First, the present disclosure may provide a path providing device capable of controlling a vehicle in an optimized manner when the path providing device is provided in a repeater.

Second, the present disclosure may allow a path providing device to be provided in a repeater that relays communication between a server and a vehicle, thereby preventing the server from being overloaded.

Third, the present disclosure may allow a path providing device to be provided in a repeater that relays communication between a server and a vehicle, thereby providing a new path providing method capable of generating EHP information for an area allocated by the repeater in an optimized manner and transmitting it to the vehicle included in the allocated area.

### BRIEF DESCRIPTION OF THE DRAWINGS

FIG. 1 illustrates an outer appearance of a vehicle.

FIG. 2 illustrates a vehicle exterior from various angles.

FIGS. 3 and 4 illustrate a vehicle interior.

FIGS. 5 and 6 are diagrams referenced to describe objects.

FIG. 7 is a block diagram of an exemplary vehicle.

FIG. 8 is a diagram of an exemplary Electronic Horizon Provider (EHP).

FIG. 9 is a block diagram of an exemplary path providing device of FIG. 8.

FIG. 10 is a diagram of an exemplary eHorizon.

FIGS. 11A and 11B are diagrams illustrating examples of a Local Dynamic Map (LDM) and an Advanced Driver Assistance System (ADAS) MAP.

FIGS. 12A and 12B are diagrams illustrating examples of method of receiving high-definition map data by a path providing device of FIG. 8.

FIG. 13 is a flowchart of an exemplary method of allowing a path providing device to receive a high-definition map and generate field-of-view information for autonomous driving.

FIG. 14 is a diagram of an exemplary processor included in a path providing device.

FIG. 15 is a conceptual view of an exemplary path providing device provided in a server.

FIG. 16 is a conceptual view of an exemplary implementation of a vehicle for receiving information from a path providing device provided in a server.

FIG. 17 is a flowchart of an exemplary control method.

FIGS. 18 and 19 are conceptual views of an exemplary path providing device provided in a repeater.

FIGS. 20, 21A and 21B are conceptual views of exemplary implementations of a server, a repeater, and a vehicle when a path providing device provided in the repeater.

FIG. 22 is a conceptual view of an exemplary function of a vehicle capable of receiving EHP information from a server and a repeater.

### DETAILED DESCRIPTION

Description will now be given in detail according to exemplary implementations disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to some implementations of the present disclosure may be understood as a conception including cars, motorcycles and the like. Hereinafter, the vehicle will be described based on a car.

The vehicle according to some implementations of the present disclosure may be a conception including all of an internal combustion engine car having an engine as a power source, a hybrid vehicle having an engine and an electric motor as power sources, an electric vehicle having an electric motor as a power source, and the like.

In the following description, a left side of a vehicle or the like refers to a left side in a driving direction of the vehicle, and a right side of the vehicle or the like refers to a right side in the driving direction.

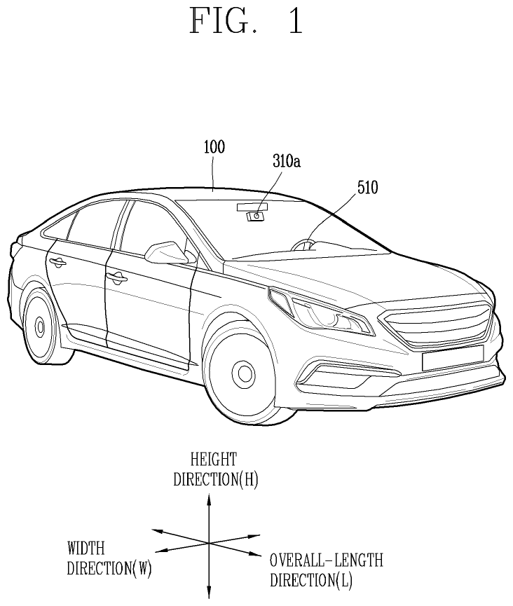

As illustrated in FIGS. 1 to 7, a vehicle 100 may include wheels turning by a driving force, and a steering input device 510 for adjusting a driving (proceeding, moving) direction of the vehicle 100.

The vehicle 100 may be an autonomous vehicle.

In some implementations, the vehicle 100 may be switched into an autonomous mode or a manual mode based on a user input.

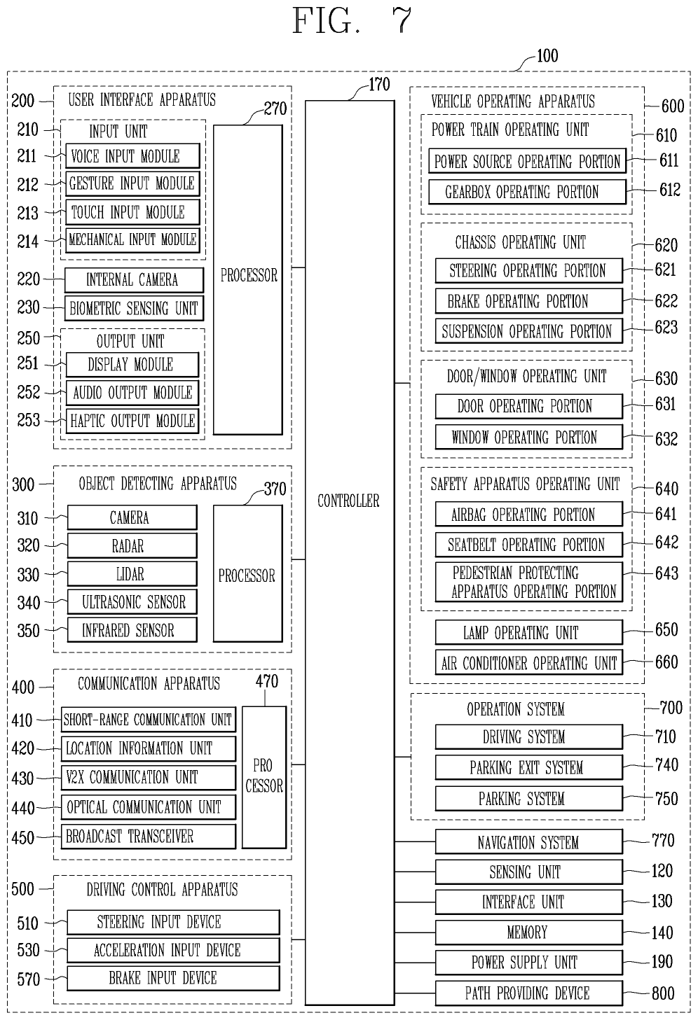

For example, the vehicle 100 may be converted from the manual mode into the autonomous mode or from the autonomous mode into the manual mode based on a user input received through a user interface apparatus 200 in FIG. 7.

The vehicle 100 may be switched into the autonomous mode or the manual mode based on driving environment information. The driving environment information may be generated based on object information provided from an object detecting apparatus 300 in FIG. 7.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400 in FIG. 7.

The vehicle 100 may be switched from the manual mode into the autonomous mode or from the autonomous module into the manual mode based on information, data, or signal provided from an external device.

When the vehicle 100 is driven in the autonomous mode, the vehicle 100 may be driven based on an operation system 700.

For example, the autonomous vehicle 100 may be driven based on information, data or signal generated in a driving system 710, a parking exit system 740, and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

As illustrated in FIG. 7, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170, a power supply unit 190, and a path providing device 800.

The vehicle 100 may include more components in addition to the components to be explained in this specification or may exclude one or more of the components described in this specification.

The user interface apparatus 200 is an apparatus that provides communication between the vehicle 100 and a user. The user interface apparatus 200 may receive a user input and provide information generated in the vehicle 100 to the user. The vehicle 100 may implement user interfaces (UIs) or user experiences (UXs) through the user interface apparatus 200.

The user interface apparatus 200 may include an input unit 210, an internal camera 220, a biometric sensing unit 230, an output unit 250, and at least one processor such as a processor 270.

The user interface apparatus 200 may include more components in addition to the components that are described in this specification or may exclude one or more of those components described in this specification.

The input unit 210 may allow the user to input information. Data collected in the input unit 210 may be analyzed by the processor 270 and processed as a user's control command.

The input unit 210 may be disposed inside the vehicle. For example, the input unit 210 may be disposed on or around a steering wheel, an instrument panel, a seat, each pillar, a door, a center console, a headlining, a sun visor, a wind shield, a window or other suitable areas in the vehicle.

The input unit 210 may include a voice input module 211, a gesture input module 212, a touch input module 213, and a mechanical input module 214.

The voice input module 211 may convert a user's voice input into an electric signal. The converted electric signal may be provided to the processor 270 or the controller 170.

The voice input module 211 may include at least one microphone.

The gesture input module 212 may convert a user's gesture input into an electric signal. The converted electric signal may be provided to the processor 270 or the controller 170.

The gesture input module 212 may include at least one of an infrared sensor or an image sensor for detecting the user's gesture input.

According to some implementations, the gesture input module 212 may detect a user's three-dimensional (3D) gesture input. For example, the gesture input module 212 may include a light emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

According to an implementation, the touch input module 213 may be integrated with the display module 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door, and/or other suitable areas in the vehicle.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing unit 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252, or a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display, and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display, and a transparent LED display. The transparent display may have adjustable transparency.

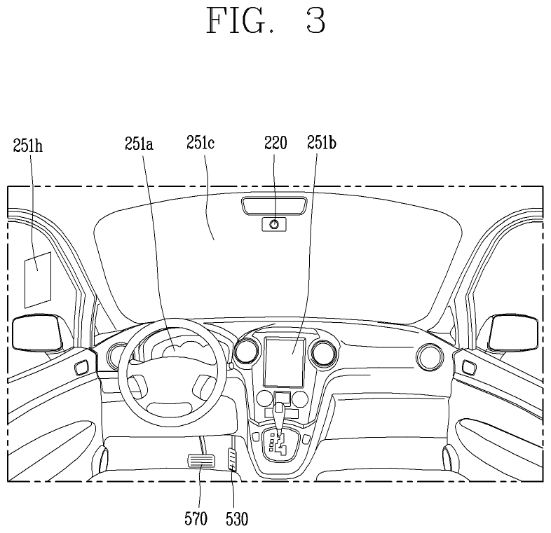

Meanwhile, the user interface apparatus 200 may include a plurality of display modules 251a to 251g as depicted in FIGS. 3, 4, and 6.

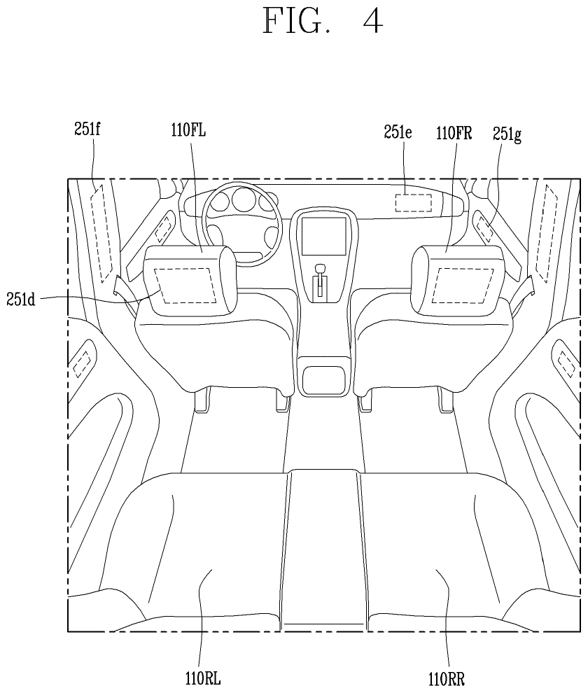

The display module 251 may be disposed on or around a steering wheel, instrument panels 251a, 251b, and 251e, (as depicted in FIGS. 3, 4, and 6), a seat 251d (as depicted in FIG. 4), each pillar 251f (as depicted in FIG. 4), a door 251g (as depicted in FIG. 4), a center console, a headlining or a sun visor, or implemented on or around a windshield 251c and/or a window 251h (as depicted in FIG. 3).

The audio output module 252 may convert an electric signal provided from the processor 270 or the controller 170 into an audio signal for output. For example, the audio output module 252 may include at least one speaker.

The haptic output module 253 may generate a tactile output. For example, the haptic output module 253 may vibrate the steering wheel, a safety belt, a seat 110FL, 110FR, 110RL, 110RR (in FIG. 4) such that the user can recognize such output.

The processor 270 may control an overall operation of each unit of the user interface apparatus 200.

In some implementations, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

The user interface apparatus 200 may also be referred to herein as a display apparatus for vehicle.

In some implementations, the user interface apparatus 200 may operate according to the control of the controller 170.

Referring still to FIG. 7, the object detecting apparatus 300 is an apparatus for detecting an object located at outside of the vehicle 100.

The object may be a variety of objects associated with driving or operation of the vehicle 100.

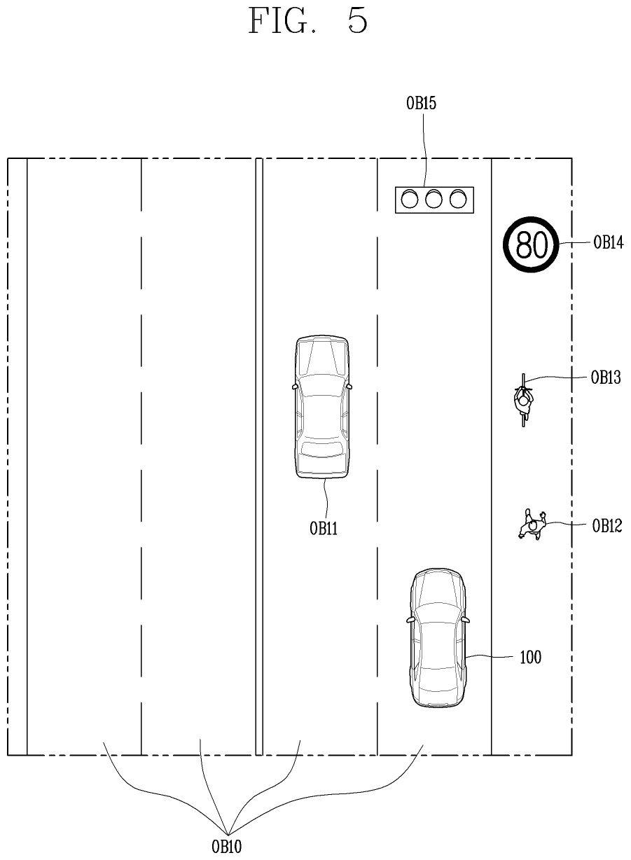

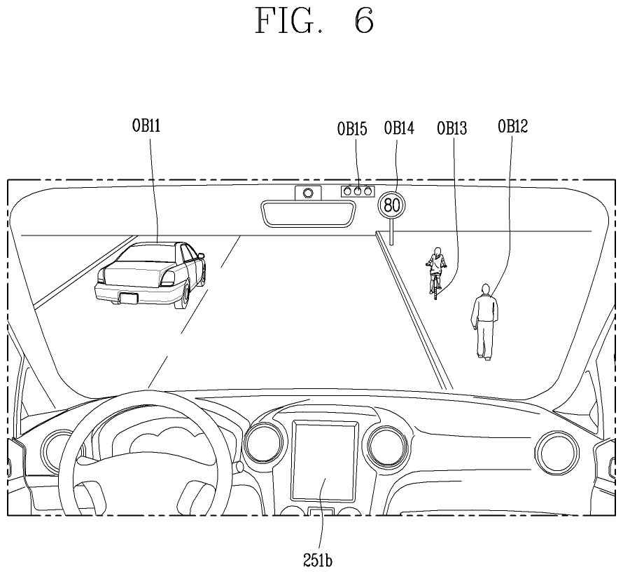

Referring to FIGS. 5 and 6, an object O may include traffic lanes OB10, another vehicle OB11, a pedestrian OB12, a two-wheeled vehicle OB13, traffic signals OB14 and OB15, light, a road, a structure, a speed hump, a terrain, an animal, and other objects.

The lane OB10 may be a driving lane, a lane next to the driving lane, or a lane on which another vehicle comes in an opposite direction to the vehicle 100. Each lane OB10 may include left and right lines forming the lane.

The another vehicle OB11 may be a vehicle which is moving near the vehicle 100. The another vehicle OB11 may be a vehicle located within a predetermined distance from the vehicle 100. For example, the another vehicle OB11 may be a vehicle moving ahead of or behind the vehicle 100.

The pedestrian OB12 may be a person located near the vehicle 100. The pedestrian OB12 may be a person located within a predetermined distance from the vehicle 100. For example, the pedestrian OB12 may be a person located on a sidewalk or roadway.

The two-wheeled vehicle OB13 may refer to a vehicle (transportation facility) that is located near the vehicle 100 and moves using two wheels. The two-wheeled vehicle OB13 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The terrain may include a mountain, a hill and the like.

In some implementations, objects may be classified into a moving object and a fixed object. For example, the moving object may include another vehicle or a pedestrian. The fixed object may include, for example, a traffic signal, a road, or a structure.

Referring to FIG. 7, the object detecting apparatus 300 may include a camera 310, a radar 320, a LiDAR 330, an ultrasonic sensor 340, an infrared sensor 350, and at least one processor such as a processor 370.

In some implementations, the object detecting apparatus 300 may further include other components in addition to the components described herein, or may exclude one or more of the components described herein.

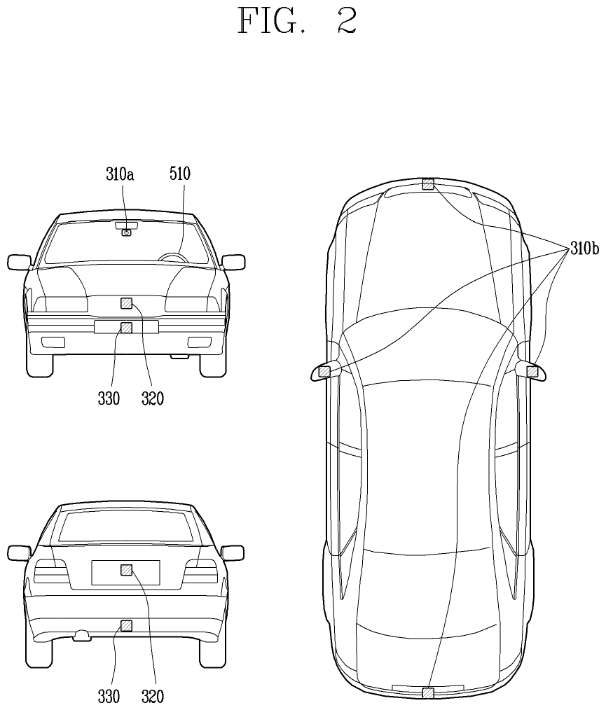

The camera 310 may be located on an appropriate portion outside the vehicle to acquire an external image of the vehicle. The camera 310 may be a mono camera, a stereo camera 310a (as depicted in FIGS. 1 and 2), an around view monitoring (AVM) camera 310b (as depicted in FIG. 2) or a 360-degree camera.

In some implementations, the camera 310 may be disposed adjacent to a front windshield within the vehicle to acquire a front image of the vehicle. Alternatively or in addition, the camera 310 may be disposed adjacent to a front bumper or a radiator grill.

Alternatively or in addition, the camera 310 may be disposed adjacent to a rear glass within the vehicle to acquire a rear image of the vehicle. Alternatively or in addition, the camera 310 may be disposed adjacent to a rear bumper, a trunk or a tail gate.

Alternatively or in addition, the camera 310 may be disposed adjacent to at least one of side windows within the vehicle to acquire a side image of the vehicle. Alternatively or in addition, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift keying (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle as depicted in FIG. 2.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a time of flight (TOP) manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle as depicted in FIG. 2.

The ultrasonic sensor 340 may include ultrasonic wave transmitting and receiving portions. The ultrasonic sensor 340 may detect an object based on an ultrasonic wave, and detect a position of the detected object, a distance from the detected object, and a relative speed with the detected object.

The ultrasonic sensor 340 may be disposed on an appropriate position outside the vehicle for detecting an object located at the front, rear, or side of the vehicle.

The infrared sensor 350 may include infrared light transmitting and receiving portions. The infrared sensor 350 may detect an object based on infrared light, and detect a position of the detected object, a distance from the detected object, and a relative speed with the detected object.

The infrared sensor 350 may be disposed on an appropriate position outside the vehicle for detecting an object located at the front, rear, or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave, which is generated when an emitted electromagnetic wave is reflected from the object, and track the object. The processor 370 may execute operations, such as a calculation of a distance from the object, a calculation of a relative speed with the object, and the like, based on the reflected electromagnetic wave.

The processor 370 may detect an object based on a reflected laser beam, which is generated when an emitted laser beam is reflected from the object, and track the object. The processor 370 may execute operations, such as a calculation of a distance from the object, a calculation of a relative speed with the object, and the like, based on the reflected laser beam.

The processor 370 may detect an object based on a reflected ultrasonic wave, which is generated when an emitted ultrasonic wave is reflected from the object, and track the object. The processor 370 may execute operations, such as a calculation of a distance from the object, a calculation of a relative speed with the object, and the like, based on the reflected ultrasonic wave.

The processor may detect an object based on reflected infrared light, which is generated when emitted infrared light is reflected from the object, and track the object. The processor 370 may execute operations, such as a calculation of a distance from the object, a calculation of a relative speed with the object, and the like, based on the reflected infrared light.

According to some implementations, the object detecting apparatus 300 may include a plurality of processors 370 or does not include the processor 370. In some implementations, each of the camera 310, the radar 320, the LiDAR 330, the ultrasonic sensor 340, and the infrared sensor 350 may include a processor, respectively.

When the processor 370 is not included in the object detecting apparatus 300, the object detecting apparatus 300 may operate according to the control of a processor of an apparatus within the vehicle 100 or the controller 170.

The object detecting apparatus 300 may operate according to the control of the controller 170.

The communication apparatus 400 is an apparatus for communicating with an external device. Here, the external device may be another vehicle, a mobile terminal or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to some implementations, the communication apparatus 400 may further include other components in addition to the components described herein, or may exclude one or more of the components described herein.

The short-range communication unit 410 is a unit for facilitating short-range communications. Suitable technologies for implementing such short-range communications include Bluetooth, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for communicating with an external device through the medium of light. The optical communication unit 440 may include a light-emitting diode for converting an electric signal into an optical signal and sending the optical signal to the exterior, and a photodiode for converting the received optical signal into an electric signal.

According to some implementations, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal, and a data broadcast signal.

The processor 470 may control an overall operation of each unit of the communication apparatus 400.

According to some implementations, the communication apparatus 400 may include a plurality of processors 470 or does not include the processor 470.

When the processor 470 is not included in the communication apparatus 400, the communication apparatus 400 may operate according to the control of a processor of another device within the vehicle 100 or the controller 170.

In some implementations, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

In some implementations, the communication apparatus 400 may operate according to the control of the controller 170.

Referring still to FIG. 7, the driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530, and a brake input device 570.

The steering input device 510 may receive an input regarding a driving (proceeding) direction of the vehicle 100 from the user. The steering input device 510 may refer to a wheel allowing a steering input in a rotating manner. According to some implementations, the steering input device 510 may also refer to a touch screen, a touch pad, or a button.

The acceleration input device 530 may receive an input for accelerating the vehicle 100 from the user. The brake input device 570 may receive an input for braking the vehicle 100 from the user. Each of the acceleration input device 530 and the brake input device 570 may refer to a pedal. According to some implementations, the acceleration input device 530 or the brake input device 570 may also refer to a touch screen, a touch pad, or a button.

In some implementations, the driving control apparatus 500 may operate according to the control of the controller 170.

Referring still to FIG. 7, the vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some implementations, the vehicle operating apparatus 600 may further include other components in addition to the components described, or may not include some of the components described.

In some implementations, the vehicle operating apparatus 600 may include a processor. Alternatively or in addition, each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

In other example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N), or parking (P).

For example, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622, and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

In some implementations, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

In some implementations, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

Referring still to FIG. 7, the safety apparatus operating unit 640 may perform an electronic control for various safety apparatuses within the vehicle 100.

The safety apparatus operating unit 640 may include an airbag operating portion 641, a seatbelt operating portion 642, and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, and 110RR (depicted in FIG. 4) using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

Referring still to FIG. 7, the lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when an internal temperature of the vehicle is high.

In some implementations, the vehicle operating apparatus 600 may include a processor. Each unit of the vehicle operating apparatus 600 may individually include a processor.

In some implementations, the vehicle operating apparatus 600 may operate according to the control of the controller 170.

Referring still to FIG. 7, the operation system 700 is a system that controls various driving modes of the vehicle 100. The operation system 700 may operate in an autonomous driving mode.

The operation system 700 may include a driving system 710, a parking exit system 740, and a parking system 750.

According to implementations, the operation system 700 may further include other components in addition to the components described herein, or may exclude one or more of the components described herein.

In some implementations, the operation system 700 may include at least one processor. Alternatively, or in addition, each unit of the operation system 700 may individually include at least one processor.

According to some implementations, the operation system 700 may be implemented by the controller 170 when it is implemented in a software configuration.

In some implementations, the operation system 700 may include at least one of the user interface apparatus 200, the object detecting apparatus 300, the communication apparatus 400, the vehicle operating apparatus 600, or the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600, and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770 and transmit a control signal to the vehicle operating apparatus 600 to park the vehicle 100.

The parking system 750 may receive object information from the object detecting apparatus 300, and transmit a control signal to the vehicle operating apparatus 600 to park the vehicle 100.

The parking system 750 may receive a signal from an external device through the communication apparatus 400, and transmit a control signal to the vehicle operating apparatus 600 to park the vehicle 100.

The navigation system 770 may provide navigation information. The navigation information may include at least one of map information, information regarding a set destination, path information according to the set destination, information regarding various objects on a path, lane information, and current location information of the vehicle 100.

The navigation system 770 may include a memory and a processor. The memory may store the navigation information. The processor may control an operation of the navigation system 770.

According to some implementations, the navigation system 770 may update stored information by receiving information from an external device through the communication apparatus 400.

According to some implementations, the navigation system 770 may be classified as a sub component of the user interface apparatus 200.

The sensing unit 120 may detect a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal, and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

In some implementations, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to some implementations, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

In some implementations, the vehicle 100 according to the present disclosure may include a path providing device 800.

The path providing device 800 may control at least one of those components illustrated in FIG. 7. From this perspective, the path providing device 800 may be the controller 170.

Without a limit to this, the path providing device 800 may be a separate device, independent of the controller 170. When the path providing device 800 is implemented as a component independent of the controller 170, the path providing device 800 may be provided on a part of the vehicle 100.

Hereinafter, description will be given of implementations in which the path providing device 800 is a component which is separate from the controller 170, for the sake of explanation. As such, according to implementations described in this disclosure, the functions (operations) and control techniques described in relation to the path providing device 800 may be executed by the controller 170 of the vehicle. That is, every detail described in relation to the path providing device 800 may be applied to the controller 170 in the same/similar manner.

Also, the path providing device 800 described herein may include some of the components illustrated in FIG. 7 and various components included in the vehicle. For the sake of explanation, the components illustrated in FIG. 7 and the various components included in the vehicle will be described with separate names and reference numbers.

Hereinafter, description will be given in more detail of a method of autonomously driving a vehicle related to the present disclosure in an optimized manner or providing path information optimized for the travel the vehicle, with reference to the accompanying drawings.

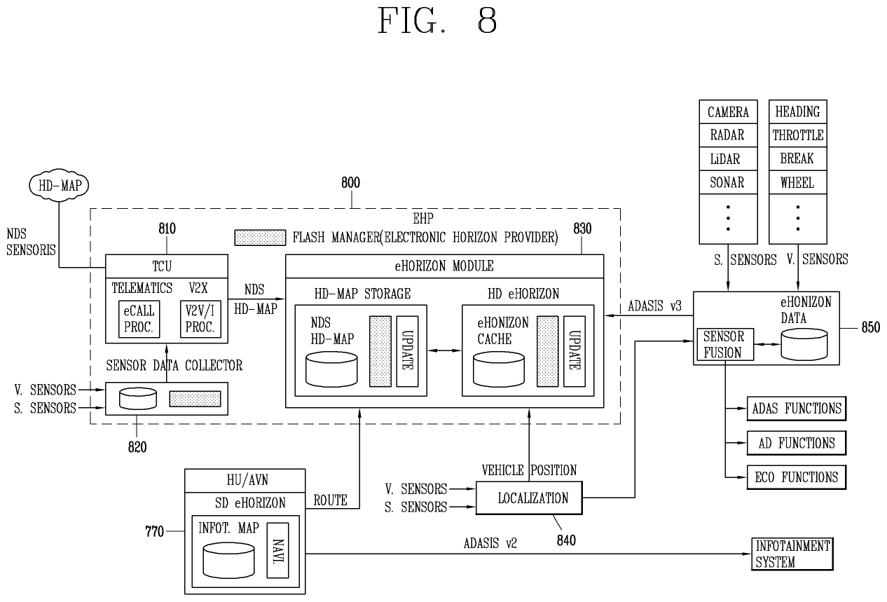

FIG. 8 is a diagram of an exemplary Electronic Horizon Provider (EHP).

Referring to FIG. 8, a path providing device 800 may autonomously control the vehicle 100 based on eHorizon (electronic Horizon).

The path providing device 800 may be an electronic horizon provider (EHP).

In some implementations, Electronic Horizon may refer to ‘ADAS Horizon’, ‘ADASIS Horizon’, ‘Extended Driver Horizon’ or ‘eHorizon’.

The eHorizon may be a software, a module, or a system that performs operations including generating vehicle's forward path information (e.g., using high-definition (HD) map data), configuring the vehicle's forward path information based on a specified standard (protocol) (e.g., a standard specification defined by the ADAS), and transmitting the configured vehicle forward path information to an application (e.g., an ADAS application, a map application, etc.) which may be installed in a module (e.g., an ECU, the controller 170, the navigation system 770, etc.) of the vehicle or in the vehicle requiring map information (or path information).

The device implementing an operation/function/control method performed by the eHorizon may be the processor 830 (EHP) and/or the path providing device 800. In some implementations, the processor 830 may be provided with or include the eHorizon described in this specification.

In some implementations, the vehicle's forward path (or a path to the destination) may be provided as a single path based on a navigation map. In some implementations, eHorizon may provide lane-based path information based on a high-definition (HD) map.

Data generated by eHorizon may refer to ‘electronic horizon data’ or ‘eHorizon data’.

The electronic horizon data may be driving plan data which is used to generate a driving control signal of the vehicle 100 in a driving (traveling) system. For example, the electronic horizon data may be driving plan data which provides a range from a point where the vehicle 100 is located to horizon.

The horizon may be a point in front of a location of the vehicle 100, by a preset distance, on the basis of a preset travel path. The horizon may refer to a point where the vehicle 100 is to reach after a predetermined time from the point, at which the vehicle 100 is currently located, along a preset travel path. Here, the travel path refers to a path for the vehicle to travel up to a final destination, and may be set by a user input.

Electronic horizon data may include horizon map data and horizon path data. The horizon map data may include at least one of topology data, ADAS data, HD map data, or dynamic data. According to some implementations, the horizon map data may include a plurality of layers of data. For example, the horizon map data may include a first layer that matches topology data, a second layer that matches ADAS data, a third layer that matches HD map data, and a fourth layer that matches dynamic data. The horizon map data may further include static object data.

Topology data may be a map created by connecting road centers. Topology data may indicate a position of a vehicle and may be in the form of data used in a navigation for a driver. For example, topology data may be road information excluding lane-related information. Topology data may be generated based on data received by an infrastructure through V2I. For example, topology data may be based on data generated in the infrastructure. By way of further example, topology data may be based on data stored in at least one memory included in the vehicle 100.

ADAS data may refer to data related to road information. ADAS data may include at least one of road slope data, road curvature data, or road speed limit data. ADAS data may further include no-passing zone data. ADAS data may be based on data generated in an infrastructure. In some implementations, ADAS data may be based on data generated by the object detecting apparatus 300. ADAS data may be named road information data.

HD map data may include detailed lane-unit topology information of a road, connection information of each lane, and feature information for localization of a vehicle (e.g., traffic signs, lane marking/attributes, road furniture, etc.). HD map data may be based on data generated in an infrastructure.

Dynamic data may include various dynamic information that may be generated on a road. For example, the dynamic data may include construction information, variable-speed lane information, road surface state information, traffic information, moving object information, and any other information associated with the road. Dynamic data may be based on data received by an infrastructure. In some implementations, dynamic data may be based on data generated by the object detecting apparatus 300.

The path providing device 800 may provide map data within a range from a location of the vehicle 100 to the horizon. The horizon path data may be a trajectory that the vehicle 100 can take within the range from the location of the vehicle 100 to the horizon. The horizon path data may include data indicating a relative probability to select one road at a decision point (e.g., fork, intersection, crossroads, etc.). Relative probability may be calculated based on a time taken to arrive at a final destination. For example, if a shorter time is taken to arrive at the final destination by selecting a first road than selecting a second road at a decision point, the probability to select the first road may be calculated higher than the probability to select the second road.

The horizon path data may further include a main path and a sub path. The main path may be a trajectory connecting roads with a higher relative probability to be selected. The sub path may be merged with or diverged from at least one point on the main path. The sub path may be a trajectory connecting at least one road having a low relative probability to be selected at the at least one decision point on the main path.

eHorizon may be classified into categories such as software, a system, and the like. eHorizon denotes a configuration of aggregating real-time events, such as road shape information of a high-definition map, real-time traffic signs, road surface conditions, accidents and the like, under a connected environment of an external server (cloud server), V2X (Vehicle to everything) or the like, and providing the information related to the aggregated real-time events to the autonomous driving system and the infotainment system.

In some implementations, eHorizon may transfer a road shape on a high-definition map and real-time events with respect to the front of the vehicle to the autonomous driving system and the infotainment system under an external server/V2X environment.

In order to effectively transfer eHorizon data (information) transmitted from eHorizon (i.e., external server) to the autonomous driving system and the infotainment system, a data specification and transmission method may be formed in accordance with a technical standard called “Advanced Driver Assistance Systems Interface Specification (ADASIS).”

The vehicle 100 may use information, which is received (generated) in eHorizon, in an autonomous driving system and/or an infotainment system. For example, the autonomous driving system may use information provided by eHorizon in safety and ECO aspects.

In terms of the safety aspect, the vehicle 100 may perform an Advanced Driver Assistance System (ADAS) function such as Lane Keeping Assist (LKA), Traffic Jam Assist (TJA) or the like, and/or an AD (AutoDrive) function such as passing, road joining, lane change or the like, by using road shape information and event information received from eHorizon and surrounding object information sensed through the localization unit 840 provided in the vehicle.

Furthermore, in terms of the ECO aspect, the path providing device 800 may receive slope information, traffic light information, and the like related to a forward road from eHorizon, to control the vehicle so as to get efficient engine output, thereby enhancing fuel efficiency.

The infotainment system may include convenience aspect. For example, the vehicle 100 may receive from eHorizon accident information, road surface condition information, and the like related to a road ahead of the vehicle, and output the received information on a display unit (e.g., Head Up Display (HUD), CID, Cluster, etc.) provided in the vehicle, so as to provide guide information for the driver to drive the vehicle safely.

eHorizon may receive position information related to various types of event information (e.g., road surface condition information, construction information, accident information, etc.) occurred on roads and/or road-based speed limit information from the vehicle 100 or other vehicles or may collect such information from infrastructures (e.g., measuring devices, sensing devices, cameras, etc.) installed on the roads.

In addition, the event information and the road-based speed limit information may be linked to map information or may be updated.

In addition, the position information related to the event information may be divided into lane units.

By using such information, the eHorizon system (EHP) can provide information necessary for the autonomous driving system and the infotainment system to each vehicle, based on a high-definition map on which road conditions (or road information) can be determined on the lane basis. For example, an Electronic Horizon (eHorizon) Provider (EHP) may provide an high-definition map using coordinates of road-related information (for example, event information, position information regarding the vehicle 100, etc.) based on a high-definition map.

The road-related information provided by the eHorizon may be information included in a predetermined area (predetermined space) with respect to the vehicle 100.

The EHP may be a component which is included in an eHorizon system and configured to perform functions provided by the eHorizon (or eHorizon system).

The path providing device 800 may be EHP, as shown in FIG. 8.

The path providing device 800 (EHP) may receive a high-definition map from an external server (or a cloud server), generate path (route) information to a destination with respect to one or more lanes of a road, and transmit the high-definition map and the path information generated with respect to the one or more lanes to a module or application (or program) of the vehicle requiring the map information and the path information.

Referring to FIG. 8, FIG. 8 illustrates an exemplary overall structure of an Electronic Horizon (eHorizon) system.

The path providing device 800 (EHP) may include a telecommunication control unit (TCU) 810 that receives a high-definition map (HD-map) from a cloud server.

The TCU 810 may be the communication apparatus 400 described above, and may include at least one of components included in the communication apparatus 400.

The TCU 810 may include a telematics module or a vehicle to everything (V2X) module.

The TCU 810 may receive an HD map that complies with the Navigation Data Standard (NDS) (or conforms to the NDS standard) from the cloud server.

In addition, the HD map may be updated by reflecting data sensed by sensors provided in the vehicle and/or sensors installed around road, according to the sensor ingestion interface specification (SENSORIS).

The TCU 810 may download the HD map from the cloud server through the telematics module or the V2X module.

In addition, the path providing device 800 may include an interface unit 820. In some implementations, the interface unit 820 may receive sensing information from one or more sensors provided in the vehicle 100.

The interface unit 820 may refer to a sensor data collector. The interface unit 820 may collect or receive information sensed by sensors (V.Sensors) provided in the vehicle for detecting a manipulation of the vehicle (e.g., heading, throttle, break, wheel, etc.) and sensors (S.Sensors) for detecting surrounding information of the vehicle (e.g., Camera, Radar, LiDAR, Sonar, etc.)

The interface unit 820 may transmit the information sensed through the sensors provided in the vehicle to the TCU 810 (or processor 830) to reflect the information in the HD map.

TCU 810 may update the HD map stored in the cloud server by transmitting the information transmitted from the interface unit 820 to the cloud server.

The path providing device 800 may include a processor 830 (or an eHorizon module).

The processor 830 may control the TCU 810 and the interface unit 820.

The processor 830 may store the HD map received through the TCU 810, and update the HD map using the information received through the interface unit 820. This operation may be performed in a storage part of the processor 830.

The processor 830 may receive first path information from an audio video navigation (AVN) or a navigation system 770.

The first path information may be route information provided in conventional systems and may be information for guiding a traveling path (travel path, driving path, driving route) to a destination. For example, the first path information provided by the conventional systems provides only one path information and does not distinguish lanes. In contrast, when the processor 830 receives the first path information, the processor 830 may generate second path information for guiding, with respect to one or more lanes of a road, a traveling path up to the destination set in the first path information, by using the HD map and the first path information. For example, the operation may be performed by a calculating part of the processor 830.

In addition, the eHorizon system may include a localization unit 840 for identifying the position of the vehicle by using information sensed through the sensors (V Sensors, S.Sensors) provided in the vehicle.

The localization unit 840 may transmit the position information of the vehicle to the processor 830 to match the position of the vehicle identified by using the sensors provided in the vehicle with the HD map.

The processor 830 may match the position of the vehicle 100 with the HD map based on the position information of the vehicle.

The processor 830 may generate horizon data, electronic horizon data, and horizon path data.

The processor 830 may generate the electronic horizon data by reflecting the traveling (driving) situation of the vehicle 100. For example, the processor 830 may generate the electronic horizon data based on traveling direction data and traveling speed data of the vehicle 100.

The processor 830 may merge the generated electronic horizon data with previously-generated electronic horizon data. For example, the processor 830 may connect horizon map data generated at a first time point with horizon map data generated at a second time point on the position basis. For example, the processor 830 may connect horizon path data generated at a first time point with horizon path data generated at a second time point on the position basis.

The processor 830 may include a memory, an HD map processing part, a dynamic data processing part, a matching part, and a path generating part.

The HD map processing part may receive HD map data from a server through the TCU. The HD map processing part may store the HD map data. According to some implementations, the HD map processing part may also process the HD map data. The dynamic data processing part may receive dynamic data from the object detecting device. The dynamic data processing part may receive the dynamic data from a server. The dynamic data processing part may store the dynamic data. In some implementations, the dynamic data processing part may process the dynamic data.

The matching part may receive an HD map from the HD map processing part. The matching part may receive dynamic data from the dynamic data processing part. The matching part may generate horizon map data by matching the HD map data with the dynamic data.

According to some implementations, the matching part may receive topology data. The matching part may receive ADAS data. The matching part may generate horizon map data by matching the topology data, the ADAS data, the HD map data, and the dynamic data. The path generating part may generate horizon path data. The path generating part may include a main path generator and a sub path generator. The main path generator may generate main path data. The sub path generator may generate sub path data.

In addition, the eHorizon system may include a fusion unit 850 for fusing information (data) sensed through the sensors provided in the vehicle and eHorizon data generated by the eHorizon module (control unit). For example, the fusion unit 850 may update an HD map by fusing sensing data sensed by the vehicle with an HD map corresponding to eHorizon data, and provide the updated HD map to an ADAS function, an AD (AutoDrive) function, or an ECO function.

In addition, the fusion unit 850 may provide the updated HD map to the infotainment system.

FIG. 8 illustrates that the path providing device 800 merely includes the TCU 810, the interface unit 820, and the processor 830, but the present disclosure is not limited thereto.

The path providing device 800 of the present disclosure may further include at least one of the localization unit 840 or the fusion unit 850.

In addition or alternatively, the path providing device 800 (EHP) may further include a navigation system 770.

With such a configuration, when at least one of the localization unit 840, the fusion unit 850, or the navigation system 770 is included in the path providing device 800 (EHP), the functions/operations/controls performed by the included configuration may be understood as being performed by the processor 830.

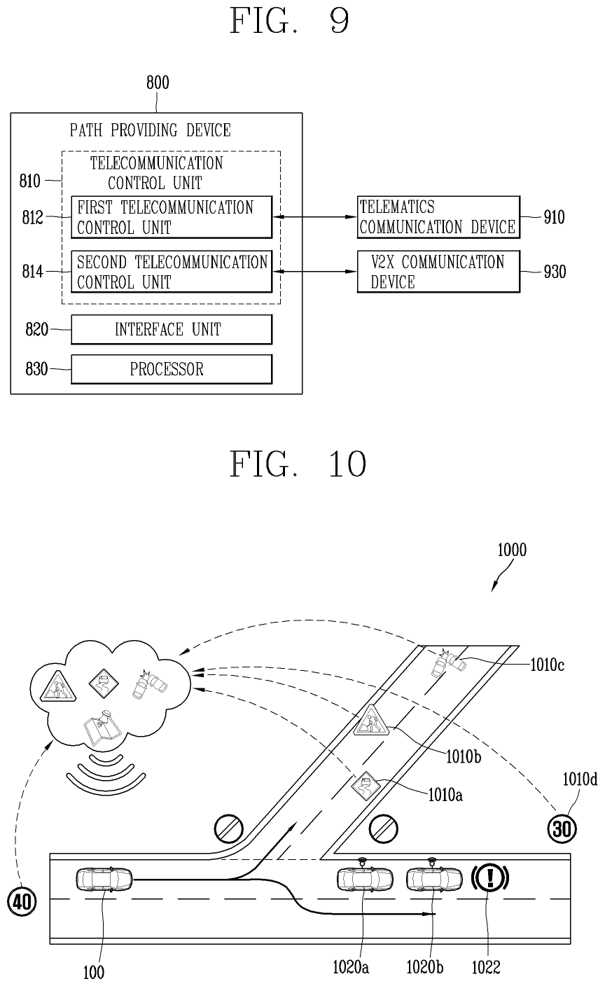

FIG. 9 is a block diagram of an exemplary path providing device (e.g., the path providing device of FIG. 8).

The path providing device refers to a device for providing a route (or path) to a vehicle. For example, the path providing device may generate and output a path on which the vehicle drives so as to recommend/provide the path on which the vehicle drives to a driver on board the vehicle.

Furthermore, the path providing device may be a device mounted on a vehicle to perform communication through CAN communication and generate messages for controlling the vehicle and/or electric components mounted on the vehicle (or an electrical part provided in the vehicle). Here, the electrical part mounted on the vehicle may denotes various components provided in the vehicle described with reference to FIGS. 1 through 8.

As described above, the message may denote an ADASIS message in which data generated by eHorizon is generated according to the ADASIS standard specification.

By way of further example, the path providing device may be located outside the vehicle, like a server or a communication device, and may perform communication with the vehicle through a mobile communication network. In this case, the path providing device may remotely control the vehicle and/or the electric components mounted on the vehicle using the mobile communication network.

The path providing device 800 is provided in the vehicle, and may be implemented as an independent device detachable from the vehicle or may be integrally installed on the vehicle to construct a part of the vehicle 100.

Referring to FIG. 9, the path providing device 800 may include a telecommunication control unit 810, an interface unit 820, and a processor 830.

The telecommunication control unit 810 may be configured to perform communications with various components provided in the vehicle. For example, the telecommunication control unit 810 may receive various information provided through a controller area network (CAN).

The telecommunication control unit 810 may include a first telecommunication control unit 812, and the first telecommunication control unit 812 may receive an HD map provided through telematics. For example, the first telecommunication control unit 812 may be configured to perform ‘telematics communication’. The first telecommunication control unit 812 performing the telematics communication may communicate with a server and the like by using a satellite navigation system or a base station provided by mobile communications such as 4G or 5G.

The first telecommunication control unit 812 may communicate with a telematics communication device 910. The telematics communication device 910 may include a server provided by a portal provider, a vehicle provider, and/or a mobile communication company.

The processor 830 of the path providing device 800 may determine absolute coordinates of road-related information (event information) based on ADAS MAP received from an external server (eHorizon) through the first telecommunication control unit 812. In addition, the processor 830 may autonomously drive the vehicle or perform a vehicle control using the absolute coordinates of the road-related information (event information).

The TCU 810 may include a second telecommunication control unit 814, and the second telecommunication control unit 814 may receive various types of information provided through vehicle to everything (V2X) communication. For example, the second telecommunication control unit 814 may be configured to perform ‘V2X communication’. The V2X communication may be a technology of exchanging or sharing information, such as traffic condition and the like, while communicating with road infrastructures and other vehicles during driving.

The second telecommunication control unit 814 may communicate with a V2X communication device 930. The V2X communication device 930 may include a mobile terminal associated with a pedestrian or a person riding a bike, a fixed terminal installed on a road, another vehicle, and the like.

Here, the another vehicle may denote at least one of vehicles existing within a predetermined distance from the vehicle 100 or vehicles approaching by a predetermined distance or shorter with respect to the vehicle 100.

The present disclosure may not be limited thereto, and the another vehicle may include all the vehicles capable of performing communication with the TCU 810. According to this specification, for the sake of explanation, an example will be described in which the another vehicle is at least one vehicle existing within a predetermined distance from the vehicle 100 or at least one vehicle approaching by a predetermined distance or shorter with respect to the vehicle 100.

The predetermined distance may be determined based on a distance capable of performing communication through the TCU 810, determined according to a specification of a product, or determined/varied based on a user's setting or V2X communication standard.

The second telecommunication control unit 814 may be configured to receive LDM data from another vehicle. The LDM data may be a V2X message (BSM, CAM, DENM, etc.) transmitted and received between vehicles through V2X communication. The LDM data may include position information related to the another vehicle.

The processor 830 may determine a position of the vehicle 100 relative to the another vehicle, based on the position information related to the vehicle 100 and the position information related to the another vehicle included in the LDM data received through the second telecommunication control unit 814.

In addition, the LDM data may include speed information regarding another vehicle. The processor 830 may also determine a relative speed of the another vehicle using speed information of the vehicle 100 and the speed information of the another vehicle. The speed information of the vehicle 100 may be calculated using a degree to which the location information of the vehicle received through the TCU 810 changes over time or calculated based on information received from the driving control apparatus 500 or the power train operating unit 610 of the vehicle 100.

The second telecommunication control unit 814 may be the V2X communication unit 430 described above.

If the TCU 810 is a component that performs communication with a device located outside the vehicle 100 using wireless communication, the interface unit 820 may be a component performing communication with a device located inside the vehicle 100 using wired or wireless communication.

The interface unit 820 may receive information related to driving of the vehicle from most of electric components provided in the vehicle 100. Information transmitted from the electric component provided in the vehicle to the path providing device 800 is referred to as ‘vehicle driving information (or vehicle travel information)’. For example, when the electric component is a sensor, the vehicle driving information may be sensing information sensed by the sensor.

Vehicle driving information may include vehicle information and surrounding information related to the vehicle. Information related to the inside of the vehicle with respect to a frame of the vehicle may be defined as the vehicle information, and information related to the outside of the vehicle may be defined as the surrounding information.

The vehicle information refers to information related to the vehicle itself. For example, the vehicle information may include a traveling speed, a traveling direction, an acceleration, an angular velocity, a location (GPS), a weight, a number of passengers on board the vehicle, a braking force of the vehicle, a maximum braking force, air pressure of each wheel, a centrifugal force applied to the vehicle, a driving (or travel) mode of the vehicle (autonomous driving mode or manual driving mode), a parking mode of the vehicle (autonomous parking mode, automatic parking mode, manual parking mode), whether or not a user is on board the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a preceding (or following) vehicle, a relative speed of a preceding (or following) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may also include ambient brightness, temperature, a position of the sun, information related to a nearby subject (a person, another vehicle, a sign, etc.), a type of a driving road surface, a landmark, line information, and driving lane information, and information required for an autonomous driving/autonomous parking/automatic parking/manual parking mode.

In addition, the surrounding information may further include a distance from an object existing around the vehicle to the vehicle, collision possibility, a type of an object, a parking space for the vehicle, an object for identifying the parking space (e.g., a parking line, a string, another vehicle, a wall, etc.), and the like.

The vehicle driving information is not limited to the example described above and may include all information generated from the components provided in the vehicle.

In some implementations, the processor 830 may be configured to control one or more electric components provided in the vehicle using the interface unit 820.

For example, the processor 830 may determine whether or not at least one of a plurality of preset or predetermined conditions is satisfied, based on vehicle driving information received through the TCU 810. Based on a satisfied condition, the processor 830 may control the one or more electric components in different ways.

In connection with the preset conditions, the processor 830 may detect an occurrence of an event in an electric component provided in the vehicle and/or application, and determine whether the detected event meets a preset condition. At this time, the processor 830 may also detect the occurrence of the event from information received through the TCU 810.

The application may be implemented, for example, as a widget, a home launcher, and the like, and may refer to various types of programs that can be executed on the vehicle. Accordingly, the application may be a program that performs various functions, such as a web browser, a video playback, message transmission/reception, schedule management, or application update.

In addition, the application may include at least one of forward collision warning (FCW), blind spot detection (BSD), lane departure warning (LDW), pedestrian detection (PD), Curve Speed Warning (CSW), or turn-by-turn navigation (TBT). For example, the occurrence of the event may be a missed call, presence of an application to be updated, a message arrival, start on, start off, autonomous travel on/off, pressing of an LCD awake key, an alarm, an incoming call, a missed notification, and the like.

In some implementations, the occurrence of the event may be a generation of an alert set in the advanced driver assistance system (ADAS), or an execution of a function set in the ADAS. For example, the occurrence of the event may be an occurrence of forward collision warning, an occurrence of blind spot detection, an occurrence of lane departure warning, an occurrence of lane keeping assist warning, or an execution of autonomous emergency braking.

In some implementations, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various electronic control units (ECUs) provided in the vehicle perform specific functions, it may be determined as the occurrence of the events. For example, when a generated event satisfies the preset condition, the processor 830 may control the interface unit 820 to display information corresponding to the satisfied condition on one or more displays provided in the vehicle.

FIG. 10 is a diagram of an exemplary eHorizon.

Referring to FIG. 10, the path providing device 800 may autonomously drive the vehicle 100 based on the eHorizon.

eHorizon may be classified into categories such as software, a system, and the like. The eHorizon denotes a configuration in which road shape information on a detailed map under a connected environment of an external server (cloud), V2X (Vehicle to everything) or the like and real-time events such as real-time traffic signs, road surface conditions, accidents and the like are merged to provide relevant information to autonomous driving systems and infotainment systems. For an example, eHorizon may refer to an external server (a cloud or a cloud server). By way of further example, eHorizon may transfer a road shape on a high-definition map and real-time events with respect to the front of the vehicle to the autonomous driving system and the infotainment system under an external server/V2X environment.

In order to effectively transfer eHorizon data (information) transmitted from eHorizon (i.e., external server) to the autonomous driving system and the infotainment system, a data specification and transmission method may be formed in accordance with a technical standard called “Advanced Driver Assistance Systems Interface Specification (ADASIS).”

The path providing device 800 may use information, which is received from eHorizon, in the autonomous driving system and/or the infotainment system. For example, the autonomous driving system may be divided into a safety aspect and an ECO aspect.

In terms of the safety aspect, the vehicle 100 may perform an Advanced Driver Assistance System (ADAS) function such as Lane Keeping Assist (LKA), Traffic Jam Assist (TJA) or the like, and/or an AD (AutoDrive) function such as passing, road joining, lane change or the like, by using road shape information and event information received from eHorizon and surrounding object information sensed through the localization unit 840 provided in the vehicle 100.

Furthermore, in terms of the ECO aspect, the path providing device 800 may receive slope information, traffic light information, and the like related to a forward road from eHorizon, to control the vehicle so as to get efficient engine output, thereby enhancing fuel efficiency.

The infotainment system may include convenience aspect. For example, the vehicle 100 may receive from eHorizon accident information, road surface condition information, and the like related to a road ahead of the vehicle and output the received information on a display unit (for example, Head Up Display (HUD), CID, Cluster, etc.) provided in the vehicle, so as to provide guide information for the driver to drive the vehicle safely.

Referring to FIG. 10, the eHorizon (external server) may receive location information related to various types of event information (e.g., road surface condition information 1010a, construction information 1010b, accident information 1010c, etc.) occurred on roads and/or road-based speed limit information 1010d from the vehicle 100 or other vehicles 1020a and 1020b or may collect such information from infrastructures (e.g., measuring devices, sensing devices, cameras, etc.) installed on the roads.

Furthermore, the event information and the road-based speed limit information may be linked to map information or may be updated.

In addition, the location information related to the event information may be divided with respect to one or more lanes of a road.

By using such information, the eHorizon (external server) can provide information necessary for the autonomous driving system and the infotainment system to each vehicle, based on a high-definition map capable of determining a road situation (or road information) with respect to one or more lanes of the road. For example, the eHorizon (external server) may provide a high-definition map using coordinates of road-related information (for example, event information, position information regarding the vehicle 100, etc.) based on a high-definition map.

The road-related information provided by the eHorizon may be information corresponding to a predetermined region (predetermined space) with respect to the vehicle 100.

In some implementations, the path providing device 800 may acquire position information related to another vehicle through communication with the another vehicle. Communication with the another vehicle may be performed through V2X (Vehicle to everything) communication, and data transmitted/received to/from the another vehicle through the V2X communication may be data in a format defined by a Local Dynamic Map (LDM) standard.

The LDM denotes a conceptual data storage located in a vehicle control unit (or ITS station) including information related to a safe and normal operation of an application (or application program) provided in a vehicle (or an intelligent transport system (ITS)). The LDM may, for example, comply with EN standards.

The LDM differs from the foregoing ADAS MAP in the data format and transmission method. For an example, the ADAS MAP may correspond to a high-definition map having absolute coordinates received from eHorizon (external server), and the LDM may denote a high-definition map having relative coordinates based on data transmitted and received through V2X communication.

The LDM data (or LDM information) denotes data mutually transmitted and received through V2X communication (vehicle to everything) (e.g., V2V (Vehicle to Vehicle) communication, V2I (Vehicle to Infra) communication, or V2P (Vehicle to Pedestrian) communication).

The LDM may be implemented, for example, by a storage for storing data transmitted and received through V2X communication, and the LDM may be formed (stored) in a vehicle control device provided in each vehicle.

The LDM data (or LDM information) denotes data mutually transmitted and received through V2X communication (vehicle to everything) (e.g., V2V (Vehicle to Vehicle) communication, V2I (Vehicle to Infra) communication, or V2P (Vehicle to Pedestrian) communication). The LDM data may include a Basic Safety Message (BSM), a Cooperative Awareness Message (CAM), and a Decentralized Environmental Notification message (DENM), and the like, for example. For example, the LDM data may refer to a V2X message or an LDM message.

The vehicle control device may efficiently manage LDM data (or V2X messages) transmitted and received between vehicles using the LDM.

Based on LDM data received via V2X communication, the LDM may store, distribute to another vehicle, and continuously update all relevant information (e.g., a location, a speed, a traffic light status, weather information, a road surface condition, and the like of the vehicle (another vehicle)) related to a traffic situation around a place where the vehicle is currently located (or a road situation for an area within a predetermined distance from a place where the vehicle is currently located).

For example, a V2X application provided in the path providing device 800 registers in the LDM, and receives a specific message such as all the DENMs in addition to a warning about a failed vehicle. Then, the LDM may automatically assign the received information to the V2X application, and the V2X application may control the vehicle based on the information assigned from the LDM.

As described above, the vehicle 100 may be controlled by using the LDM formed by the LDM data collected through V2X communication.

The LDM may provide road-related information to the vehicle control device. The road-related information provided by the LDM provides only a relative distance and a relative speed with respect to another vehicle (or an event generation point), other than map information having absolute coordinates. For example, the vehicle 100 may perform autonomous driving using an ADAS MAP (absolute coordinates HD map) according to the ADASIS standard provided by eHorizon, but the map may be used only to determine a road condition in a surrounding area of the vehicle.

In addition, the vehicle 100 may perform autonomous driving using an LDM (relative coordinates HD map) formed by LDM data received through V2X communication, but there is a limitation in that accuracy is inferior due to insufficient absolute position information.

The path providing device 800 included in the vehicle 100 may generate a fused definition map using the ADAS MAP received from the eHorizon and the LDM data received through the V2X communication, and control (autonomously drive) the vehicle in an optimized manner using the fused definition map.

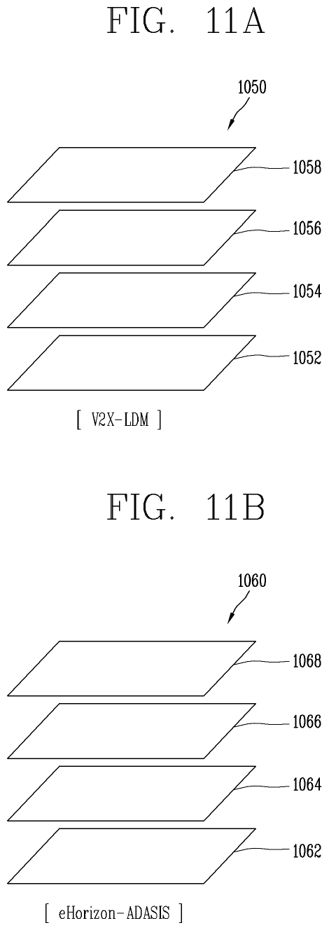

11A illustrates an example of a data format of LDM data (or LDM) transmitted and received between vehicles via V2X communication, and FIG. 11B illustrates an example of a data format of an ADAS MAP received from an external server (eHorizon).

Referring to FIG. 11A, the LDM data (or LDM) 1050 may be formed to have four layers of data.

The LDM data 1050 may include a first layer 1052, a second layer 1054, a third layer 1056 and a fourth layer 1058.

The first layer 1052 may include static information, for example, map information, among road-related information.

The second layer 1054 may include landmark information (e.g., specific place information specified by a maker among a plurality of place information included in the map information) among information associated with roads. The landmark information may include location information, name information, size information, and the like.

The third layer 1056 may include traffic situation related information (e.g., traffic light information, construction information, accident information, etc.) among information associated with roads. The construction information and the accident information may include position information.

The fourth layer 1058 may include dynamic information (e.g., object information, pedestrian information, other vehicle information, etc.) among the road-related information. The object information, pedestrian information, and other vehicle information may include location information.

For example, the LDM data 1050 may include information sensed through a sensing unit of another vehicle or information sensed through a sensing unit of the vehicle of the present disclosure, and may include road-related information that is transformed in real time as it goes from the first layer to the fourth layer.

Referring to FIG. 11B, the ADAS MAP may be formed to have four layers of data similar to the LDM data.

The ADAS MAP 1060 may denote data received from eHorizon and formed to conform to the ADASIS specification.

The ADAS MAP 1060 may include a first layer 1062, a second layer 1064, a third layer 1066, and a fourth layer 1068.

The first layer 1062 may include topology information. The topology information, for example, is information that explicitly defines a spatial relationship, and may indicate map information.

The second layer 1064 may include landmark information (e.g., specific place information specified by a maker among a plurality of place information included in the map information) among information associated with the road. The landmark information may include position information, name information, size information, and the like.

The third layer 1066 may include high-definition map information. The high-definition map information may be referred to as an HD-MAP, and road-related information (e.g., traffic light information, construction information, accident information) may be recorded in the lane unit. The construction information and the accident information may include location information.

The fourth layer 1068 may include dynamic information (e.g., object information, pedestrian information, other vehicle information, etc.). The object information, pedestrian information, and other vehicle information may include location information.

For example, the ADAS MAP 1060 may include road-related information that is transformed in real time as it goes from the first layer to the fourth layer, similarly to the LDM data 1050.

The processor 830 may autonomously drive the vehicle 100. For example, the processor 830 may autonomously drive the vehicle 100 based on vehicle driving information sensed through various electric components provided in the vehicle 100 and information received through the TCU 810.

More specifically, the processor 830 may control the TCU 810 to acquire the position information of the vehicle. For example, the processor 830 may acquire the position information (location coordinates) of the vehicle 100 through the location information unit 420 of the TCU 810.

Furthermore, the processor 830 may control the first telecommunication control unit 812 of the TCU 810 to receive map information from an external server. Here, the first telecommunication control unit 812 may receive ADAS MAP from the external server (eHorizon). The map information may be included in the ADAS MAP.

In addition, the processor 830 may control the second telecommunication control unit 814 of the TCU 810 to receive position information of another vehicle from the another vehicle. Here, the second telecommunication control unit 814 may receive LDM data from the another vehicle. The position information of the another vehicle may be included in the LDM data.

The another vehicle denotes a vehicle existing within a predetermined distance from the vehicle 100, and the predetermined distance may be a communication-available distance of the TCU 810 or a distance set by a user.

The processor 830 may control the communication unit to receive the map information from the external server and the position information of the another vehicle from the another vehicle.

Furthermore, the processor 830 may fuse the acquired position information of the vehicle and the received position information of the another vehicle into the received map information, and control the vehicle 100 based on at least one of the fused map information or vehicle-related information sensed through the sensing unit 120.

Here, the map information received from the external server may denote highly detailed map information (HD-MAP) included in the ADAS MAP. The HD map information may be recorded with road-related information with respect to one or more lanes of a road.

The processor 830 may fuse the position information of the vehicle 100 and the position information of the another vehicle into the map information with respect to one or more lanes of a road. In addition, the processor 830 may fuse the road-related information received from the external server and the road-related information received from the another vehicle into the map information with respect to one or more lanes of a road.

The processor 830 may generate ADAS MAP required for the control of the vehicle using the ADAS MAP received from the external server and the vehicle-related information received through the sensing unit 120. More specifically, the processor 830 may apply the vehicle-related information sensed within a predetermined range through the sensing unit 120 to the map information received from the external server. Here, the predetermined range may be an available distance which can be sensed by an electric component provided in the vehicle 100 or may be a distance set by a user.

The processor 830 may control the vehicle by applying the vehicle-related information sensed within the predetermined range through the sensing unit to the map information and then additionally fusing the location information of the another vehicle thereto. For example, when the vehicle-related information sensed within the predetermined range through the sensing unit is applied to the map information, the processor 830 may only use the information within the predetermined range from the vehicle, and thus a range capable of controlling the vehicle may be local.

However, the position information of the another vehicle received through the V2X module may be received from the another vehicle located out of the predetermined range. It may be because the communication-available distance of the V2X module communicating with the another vehicle through the V2X module is farther than a predetermined range of the sensing unit 120.

As a result, the processor 830 may fuse the location information of the another vehicle included in the LDM data received through the second telecommunication control unit 814 into the map information on which the vehicle-related information has been sensed, so as to acquire the location information of the another vehicle located in a broader range and more effectively control the vehicle using the acquired information. For example, it is assumed that a plurality of other vehicles is crowded ahead in a lane in which the vehicle 100 travels, and it is also assumed that the sensing unit can sense only location information related to the immediately preceding vehicle. In this case, when only vehicle-related information sensed within a predetermined range on map information is used, the processor 830 may generate a control command to control the vehicle such that the vehicle overtakes the preceding vehicle.

However, a plurality of other vehicles may be actually present ahead, which may make the vehicle difficult to overtake the other vehicles. At this time, the vehicle 100 may acquire the location information of another vehicle received through the V2X module. Here, the received location information of the another vehicle may include location information related to not only the vehicle immediately in front of the vehicle 100 (or the preceding vehicle) but also a plurality of other vehicles in front of the preceding vehicle.

The processor 830 may additionally fuse the location information related to the plurality of other vehicles acquired through the V2X module into map information to which the vehicle-related information is applied, so as to determine a situation where it is inappropriate to overtake the preceding vehicle.

With such configuration, the vehicle 100 can overcome the technical limitation associated with conventional systems that only vehicle-related information acquired through the sensing unit 120 is merely fused to high-definition map information and thus autonomous driving is enabled only within a predetermined range. For example, vehicle 100 can achieve more accurate and stable vehicle control by additionally fusing information related to other vehicles (e.g., speeds, locations of other vehicles), which have been received from the other vehicles located at a farther distance than the predetermined range through the V2X module, as well as vehicle-related information sensed through the sensing unit, into map information.

Vehicle control described herein may include at least one of autonomously driving the vehicle 100 or outputting a warning message associated with the driving of the vehicle.

Hereinafter, description will be given in more detail of a method in which a processor controls a vehicle using LDM data received through a V2X module, ADAS MAP received from an external server (eHorizon), and vehicle-related information sensed through a sensing unit provided in the vehicle, with reference to the accompanying drawings.

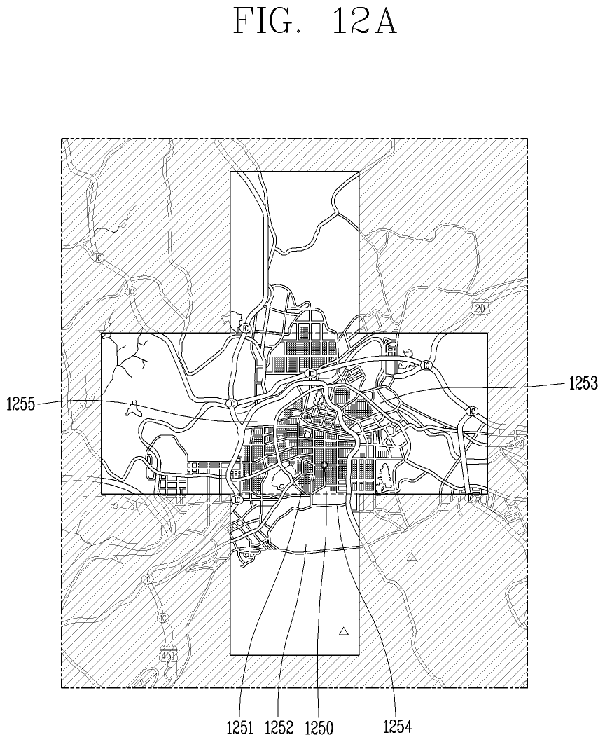

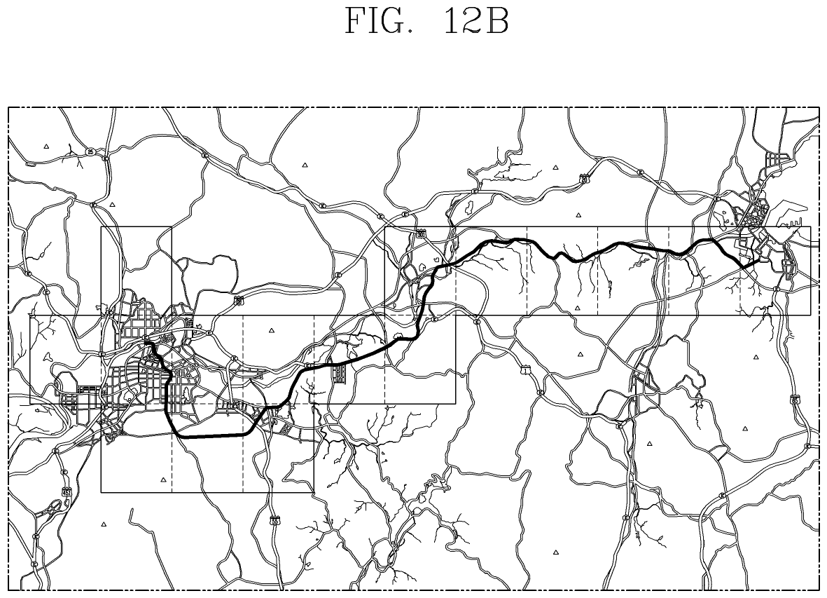

FIGS. 12A and 12B are exemplary views illustrating a method in which a communication device receives high-definition map data.

The server may divide HD map data into tile units and provide them to the path providing device 800. The processor 830 may receive HD map data in the tile units from the server or another vehicle through the TCU 810. Hereinafter, HD map data received in tile units is referred to as ‘HD map tile’.

The HD map data is divided into tiles having a predetermined shape, and each tile corresponds to a different portion of the map. By connecting all the tiles, the full HD map data may be acquired. Since the HD map data has a high capacity, the vehicle 100 may be provided with a high-capacity memory in order to download and use the full HD map data. As communication technologies are developed, it is more efficient to download, use, and delete HD map data in tile units, rather than to provide the high-capacity memory in the vehicle 100.

For the convenience of description, a case in which the predetermined shape is rectangular is described as an example, but the predetermined shape may be modified to various polygonal shapes.

The processor 830 may store the downloaded HD map tiles in the memory 140. In addition, when a storage unit (or cache memory) is provided in the path providing device, the processor 830 may store (or temporarily store) the downloaded HD map tile in the storage unit provided in the path providing device.

The processor 830 may delete the stored HD map tile. For example, the processor 830 may delete the HD map tile when the vehicle 100 leaves an area corresponding to the HD map tile. By way of further example, the processor 830 may delete the HD map tile when a preset time elapses after storage.

As illustrated in FIG. 12A, when there is no preset destination, the processor 830 may receive a first HD map tile 1251 including a location (position) 1250 of the vehicle 100. The server receives data of the location 1250 of the vehicle 100 from the vehicle 100, and transmits the first HD map tile 1251 including the location 1250 of the vehicle 100 to the vehicle 100. In addition, the processor 830 may receive HD map tiles 1252, 1253, 1254, and 1255 around the first HD map tile 1251. For example, the processor 830 may receive the HD map tiles 1252, 1253, 1254, and 1255 that are adjacent to top, bottom, left, and right sides of the first HD map tile 1251, respectively. In this case, the processor 830 may receive a total of five HD map tiles. For example, the processor 830 may further receive HD map tiles located in a diagonal direction, together with the HD map tiles 1252, 1253, 1254, and 1255 adjacent to the top, bottom, left, and right sides of the first HD map tile 1251. In this case, the processor 830 may receive a total of nine HD map tiles.

As illustrated in FIG. 12B, when there is a preset destination, the processor 830 may receive tiles associated with a path from the location 1250 of the vehicle 100 to the destination. The processor 830 may receive a plurality of tiles to cover the path.

In some implementations, the processor 830 may receive all the tiles covering the path at one time.

Alternatively, the processor 830 may receive the entire tiles in a dividing manner while the vehicle 100 travels along the path. For example, the processor 830 may receive only some of the entire tiles based on the location of the vehicle 100 while the vehicle 100 travels along the path. Thereafter, the processor 830 may continuously receive tiles during the travel of the vehicle 100 and delete the previously received tiles.

The processor 830 may generate electronic horizon data based on the HD map data.

The vehicle 100 may travel in a state where a final destination is set. The final destination may be set based on a user input received via the user interface apparatus 200 or the communication apparatus 400. According to some implementations, the final destination may be set by the driving system 710.

In the state where the final destination is set, the vehicle 100 may be located within a preset distance from a first point during driving. When the vehicle 100 is located within the preset distance from the first point, the processor 830 may generate electronic horizon data having the first point as a start point and a second point as an end point. The first point and the second point may be points on the path heading to the final destination. The first point may be described as a point where the vehicle 100 is located or will be located in the near future. The second point may be described as the horizon described above.

The processor 830 may receive an HD map of an area including a section from the first point to the second point. For example, the processor 830 may request an HD map for an area within a predetermined radial distance from the section between the first point and the second point and receive the requested HD map.

The processor 830 may generate electronic horizon data for the area including the section from the first point to the second point, based on the HD map. The processor 830 may generate horizon map data for the area including the section from the first point to the second point. The processor 830 may generate horizon path data for the area including the section from the first point to the second point. The processor 830 may generate a main path for the area including the section from the first point to the second point. The processor 830 may generate data of a sub path for the area including the section from the first point to the second point.

When the vehicle 100 is located within a preset distance from the second point, the processor 830 may generate electronic horizon data having the second point as a start point and a third point as an end point. The second point and the third point may be points on the path heading to the final destination. The second point may be described as a point where the vehicle 100 is located or will be located in the near future. The third point may be described as the horizon described above. In some implementations, the electronic horizon data having the second point as the start point and the third point as the end point may be geographically connected to the electronic horizon data having the first point as the start point and the second point as the end point.

The operation of generating the electronic horizon data using the second point as the start point and the third point as the end point may be performed by correspondingly applying the operation of generating the electronic horizon data having the first point as the start point and the second point as the end point.

According to some implementations, the vehicle 100 may travel even when the final destination is not set.

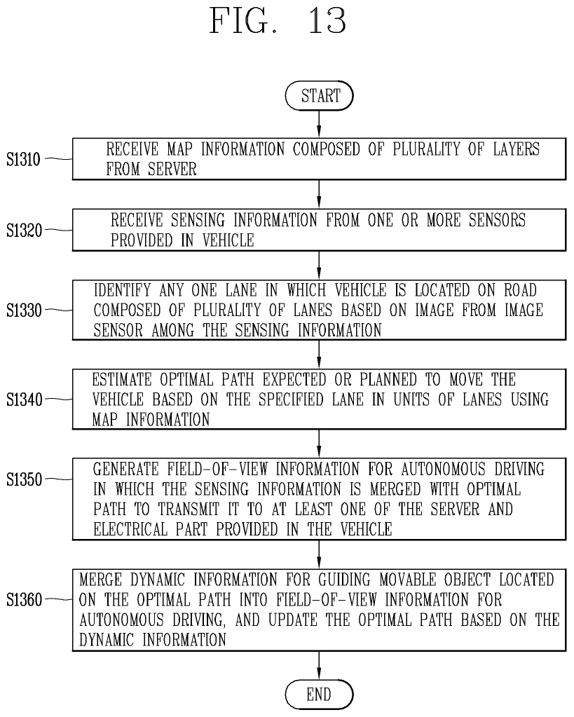

FIG. 13 is a flowchart of an exemplary path providing method of the path providing device of FIG. 9.

The processor 830 may receive a high-definition map from an external server.

Specifically, the processor 830 may receive map information (HD map, high-definition map) including a plurality of layers of data from a server (external server, cloud server) (S1310).

The external server is an example of the telematics communication device 910 as a device capable of communicating through the first telecommunication control unit 812. The high-definition map is composed of a plurality of layers of data. Furthermore, the high-definition map may include at least one of the four layers described above with respect to FIG. 11B as an ADAS MAP.

The map information may include horizon map data described above. The horizon map data may refer to an ADAS MAP (or LDM MAP) or HD MAP data including a plurality of layers of data while satisfying the ADASIS standard described with respect to FIG. 11B.

In addition, the processor 830 of the path providing device 800 may receive sensing information from one or more sensors provided in the vehicle (S1320). The sensing information may refer to information sensed by each sensor (or information processed after being sensed). The sensing information may include various information according to the types of data that can be sensed by the sensor.

The processor 830 may identify any one lane in which the vehicle 100 is located on a road composed of a plurality of lanes, based on an image (or video) received from an image sensor among sensing information (S1330). Here, the lane may refer to a lane in which the vehicle 100 currently equipped with the path providing device 800 is driving.

The processor 830 may determine a lane in which the vehicle 100 equipped with the path providing device 800 is driving by using (analyzing) an image (or video) received from an image sensor (or camera) among the sensors.

In addition, the processor 830 may estimate an optimal path that is expected or planned to move the vehicle 100 based on the identified lane in units of lanes using map information (S1340). Here, the optimal path may refer to the foregoing horizon path data or main path described above. However, the present disclosure is not limited thereto, and the optimal path may further include a sub path. Here, the optimal path may be referred to as a Most Preferred Path or Most Probable Path, and may be abbreviated as MPP.

For example, the processor 830 may predict or plan an optimal path in which the vehicle 100 can travel to a destination based on a specific lane in which the vehicle 100 is driving, using map information.

The processor 830 may generate field-of-view (autonomous driving visibility) information for autonomous driving in which sensing information is merged with an optimal path to transmit it to at least one of electrical parts provided in a server or a vehicle (S1350).

Here, the field-of-view information for autonomous driving may refer to electronic horizon information (or electronic horizon data) described above. The autonomous driving horizon information, as information (or data, environment) used by the vehicle 100 to perform autonomous driving in units of lanes, may denote environmental data for autonomous driving in which all information (map information, vehicles, things, moving objects, environment, weather, etc.) within a predetermined range are merged based on a road or an optimal path including a path in which the vehicle 100 moves, as illustrated in FIG. 10. The environmental data for autonomous driving may denote data (or a comprehensive data environment), based on which the processor 830 of the vehicle 100 allows the vehicle 100 to perform autonomous driving or calculates an optimal path of the vehicle 100.

In some implementations, the field-of-view information for autonomous driving may denote information for guiding a driving path in units of lanes. This is information in which at least one of sensing information or dynamic information is merged into an optimal path, and finally, may be information for guiding a driving path in units of lanes.

When the field-of-view information for autonomous driving refers to information for guiding a driving path in units of lanes, the processor 830 may generate different field-of-view information for autonomous driving according to whether a destination is set in the vehicle 100.

For an example, when the destination is set in the vehicle 100, the processor 830 may generate field-of-view information for autonomous driving to guide a driving path to the destination in units of lanes.

By way of further example, when no destination is set in the vehicle 100, the processor 830 may calculate a main path (most preferred path, MPP) having the highest possibility that the vehicle 100 may drive, and generate field-of-view for autonomous driving to guide the main path (MPP) in units of lanes. In this case, the field-of-view information for autonomous driving may further include sub path information on sub paths branched from the most preferred path (MPP) for the vehicle 100 to be movable at a higher probability than a predetermined reference.

The field-of-view information for autonomous driving may be formed to provide a driving path to the destination for each lane indicated on a road, thereby providing more precise and detailed path information. It may be path information conforming to the standard of ADASIS v3.

The processor 830 may merge dynamic information for guiding a movable object located on an optimal path to field-of-view information for autonomous driving, and update the optimal path based on the dynamic information (S1360). The dynamic information may be included in map information received from a server, and may be information included in any one (e.g., a fourth layer 1068) of a plurality of layers of data.

The electrical part provided in the vehicle may refer to various components provided in the vehicle, and may include, for example, sensors, lamps, and the like. The electrical part provided in the vehicle may be referred to as an eHorizon Receiver (EHR) in terms of receiving an ADASIS message including field-of-view information for autonomous driving from the processor 830.

The processor 830 may refer to an eHorizon provider (EHP) in terms of providing (transmitting) an ADASIS Message including field-of-view information for autonomous driving.

The ADASIS message including the field-of-view information for autonomous driving may refer to a message in which the field-of-view information for autonomous driving is converted in accordance with the ADASIS standard.

The foregoing description will be summarized as follows.

The processor 830 may generate field-of-view for autonomous driving to guide a road located in the front of the vehicle in units of lanes using the high-definition map.

The processor 830 may receive sensing information from one or more sensors provided in the vehicle 100 through the interface unit 820. The sensing information may be vehicle driving information.

The processor 830 may identify any one lane in which the vehicle is located on a road made up of a plurality of lanes based on an image received from an image sensor among the sensing information. For example, when the vehicle 100 is driving in a first lane on a 8-lane road, the processor 830 may identify the first lane as a lane in which the vehicle 100 is located based on the image received from the image sensor.

The processor 830 may estimate an optimal path that is expected or planned to move the vehicle 100 based on the identified lane in units of lanes using the map information.

Here, the optimal path may refer to a Most Preferred Path or Most Probable Path, and may be abbreviated as MPP.

The vehicle 100 may drives autonomously along the optimal path. When driving manually, the vehicle 100 may provide navigation information that guides the optimal path to the driver.

The processor 830 may generate field-of-view information for autonomous driving in which the sensing information is merged into the optimal path. The field-of-view information for autonomous driving may be referred to as “eHorizon” or “electronic horizon” or “electronic horizon data” or an “ADASIS message” or a “field-of-view information tree graph.”

The processor 830 may generate different field-of-view information for autonomous driving depending on whether or not a destination is set in the vehicle 100.

For example, when the destination is set in the vehicle 100, the processor 830 may generate an optimal path for guiding a driving path to the destination in units of lanes using field-of-view information for autonomous driving.

By way of further example, when a destination is not set in the vehicle 100, the processor 830 may calculate a main path in which the vehicle 100 is most likely to drive in units of lanes using field-of-view information for autonomous driving. In this case, the field-of-view information for autonomous driving may further include sub path information on sub paths branched from the most preferred path (MPP) for the vehicle 100 to be movable at a higher probability than a predetermined reference.

The field-of-view information for autonomous driving may be formed to provide a driving path to the destination for each lane indicated on a road, thereby providing more precise and detailed path information. The path information may be path information conforming to the standard of ADASIS v3.

The field-of-view information for autonomous driving may be provided by subdividing a path in which the vehicle must drive or a path in which the vehicle can drive in units of lanes. The field-of-view information for autonomous driving may include information for guiding a driving path to a destination in units of lanes. When the field-of-view information for autonomous driving is displayed on a display mounted on the vehicle 100, guide lines for guiding lanes that can be driven on a map and information within a predetermined range (e.g., roads, landmarks, other vehicles, surrounding objects, weather information, etc.) based on the vehicle may be displayed. Moreover, a graphic object indicating the location of the vehicle 100 may be included in at least one lane on which the vehicle 100 is located among a plurality of lanes included in the map.

Dynamic information for guiding a movable object located on the optimal path may be merged into the field-of-view information for autonomous driving. The dynamic information may be received at the processor 830 through the telecommunication control unit 810 and/or the interface unit 820, and the processor 830 may update the optimal path based on the dynamic information. As the optimal path is updated, the field-of-view information for autonomous driving is also updated.

The dynamic information may be referred to as dynamic information, and may include dynamic data.

The processor 830 may provide the field-of-view information for autonomous driving to at least one electrical part provided in the vehicle. Moreover, the processor 830 may provide the field-of-view information for autonomous driving to various applications installed in the system of the vehicle 100.

The electrical part may refer to any communicable device mounted on the vehicle 100, and may include the components described above with reference to FIGS. 1 through 9 (e.g., the components 120-700 described above with reference to FIG. 7). For example, an object detecting apparatus 300 such as a radar and a lidar, a navigation system 770, a vehicle operating apparatus 600, and the like may be included in the electrical part.

In addition, the electrical part may further include an application executable in the processor 830 or a module that executes the application.

The electrical part may perform its own function to be carried out based on the field-of-view information for autonomous driving.

The field-of-view information for autonomous driving may include a path in units of lanes and a location of the vehicle 100, and may include dynamic information including at least one object that must be sensed by the electrical part. The electrical part may reallocate a resource to sense an object corresponding to the dynamic information, determine whether the dynamic information matches sensing information sensed by itself, or change a setting value for generating sensing information.

The field-of-view information for autonomous driving may include a plurality of layers, and the processor 830 may selectively transmit at least one of the layers according to an electrical part that receives the field-of-view information for autonomous driving.

Specifically, the processor 830 may select at least one of a plurality of layers included in the field-of-view information for autonomous driving, based on at least one of a function being executed by the electrical part or a function scheduled to be executed. In addition, the processor 830 may transmit the selected layer to the electronic part, but the unselected layer may not be transmitted to the electrical part.

The processor 830 may receive external information generated by an external device from the external device located within a predetermined range with respect to the vehicle.

The predetermined range is a distance at which the second telecommunication control unit 914 can perform communication, and may vary according to the performance of the second telecommunication control unit 814. When the second telecommunication control unit 814 performs V2X communication, a V2X communication range may be defined as the predetermined range.

Moreover, the predetermined range may vary according to an absolute speed of the vehicle 100 and/or a relative speed with respect to the external device.

The processor 830 may determine the predetermined range based on the absolute speed of the vehicle 100 and/or the relative speed with respect to the external device, and allow communication with an external device located within the determined predetermined range.

Specifically, external devices capable of communicating through the second telecommunication control unit 814 may be classified into a first group or a second group based on the absolute speed of the vehicle 100 and/or the relative speed with respect to the external device. External information received from an external device included in the first group is used to generate dynamic information described below, but external information received from an external device included in the second group is not used to generate the dynamic information. Even when external information is received from an external device included in the second group, the processor 830 may ignore the external information.

The processor 830 may generate dynamic information of an object that must be sensed by at least one electrical part provided in the vehicle based on the external information, and may match the dynamic information to the field-of-view information for autonomous driving.

For an example, the dynamic information may correspond to the fourth layer described above with reference to FIGS. 11A and 11B.

As described above with respect to FIGS. 11A and 11B, the path providing device 800 may receive ADAS MAP and/or LDM data. Specifically, the ADAS MAP may be received from the telematics communication device 910 through the first telecommunication control unit 812 and the LDM data may be received from the V2X communication device 920 through the second telecommunication control unit 814.

The ADAS MAP and the LDM data may be composed of a plurality of layers of data each having the same format. The processor 830 may select at least one layer from the ADAS MAP, select at least one layer from the LDM data, and generate the field-of-view information for autonomous driving composed of the selected layers.

For example, the processor 830 may select the first to third layers of the ADAS MAP, select the fourth layer of the LDM data, and generate one field-of-view information for autonomous driving in which four layers are combined into one. In this case, the processor 830 may transmit a reject message for rejecting the transmission of the fourth layer to the telematics communication device 910. It is because the first telecommunication control unit 812 uses less resources to receive some information excluding the fourth layer than to receive all the information including the fourth layer. Part of the ADAS MAP may be combined with part of the LDM data to use mutually complementary information.

In some implementations, the processor 830 may select the first to fourth layers of the ADAS MAP, select the fourth layer of the LDM data, and generate one field-of-view information for autonomous driving in which five layers are combined into one. In this case, priority may be given to the fourth layer of the LDM data. When there is discrepancy information that does not match the fourth layer of the LDM data in the fourth layer of the ADAS MAP, the processor 830 may delete the discrepancy information or correct the discrepancy information based on the LDM data.

The dynamic information may be object information for guiding a predetermined object. For example, at least one of a location coordinate for guiding the location of the predetermined object, and information for guiding the shape, size, and type of the predetermined object may be included in the dynamic information.

The predetermined object may denote an object that obstructs driving in the corresponding lane among objects that can drive on a road.

For example, the predetermined object may include a bus stopping at a bus stop, a taxi stopping at a taxi stop, a truck dropping a courier, and the like.

By way of further example, the predetermined object may include a garbage collection vehicle driving at a constant speed or below, or a large vehicle (e.g., truck or container truck, etc.) determined to obstruct view.

As another example, the predetermined object may include an object indicating an accident, road damage, or construction.

As described above, the predetermined object may include all types of objects disallowing the driving of the present vehicle 100 or obstructing the lane not to allow the vehicle 100 to drive. Traffic signals such as ice roads, pedestrians, other vehicles, construction signs, and traffic lights to be avoided by the vehicle 100 may correspond to the predetermined object and may be received by the path providing device 800 as the external information.

Meanwhile, the processor 830 may determine whether a predetermined object guided by the external information is located within a reference range based on the driving path of the vehicle 100.

Whether or not the predetermined object is located within the reference range may vary depending on the lane on which the vehicle 100 drives and the location of the predetermined object.

For example, external information for guiding a sign indicating the construction of a third lane ahead 1 km while driving on a first lane may be received. When the reference range is set to 1 m with respect to the vehicle 100, the sign is located out of the reference range. It is because when the vehicle 100 continues to drive on the first lane, the third lane is located out of 1 m with respect to the vehicle 100. On the contrary, when the reference range is set to 10 m with respect to the vehicle 100, the sign is located within the reference range.

The processor 830 may generate the dynamic information based on the external information when the predetermined object is located within the reference range, but does not generate the dynamic information when the predetermined object is located out of the reference range. In other words, the dynamic information may be generated only when the predetermined object guided by the external information is located on a driving path of the vehicle 100 or within a reference range capable of affecting the driving path of the vehicle 100.

Since the path providing device combines information received through the first telecommunication control unit and information received through the second telecommunication control unit into one information during the generation of field-of-view information for autonomous driving, optimal field-of-view information for autonomous driving in which information provided through different telecommunication control units are mutually complemented. It is because the information received through the first telecommunication control unit has a restriction in that it is unable to reflect the information in real time, but the information received through the second telecommunication control unit complements the real-time property.

Further, since when there is information received through the second telecommunication control unit, the processor 830 controls the first telecommunication control unit so as not to receive the corresponding information, it may be possible to use the bandwidth of the first telecommunication control unit less than the related art. In other words, the resource use of the first telecommunication control unit may be minimized.

Hereinafter, the processor 830 capable of performing a function/operation/control method of eHorizon as described above will be described in more detail with reference to the accompanying drawings.

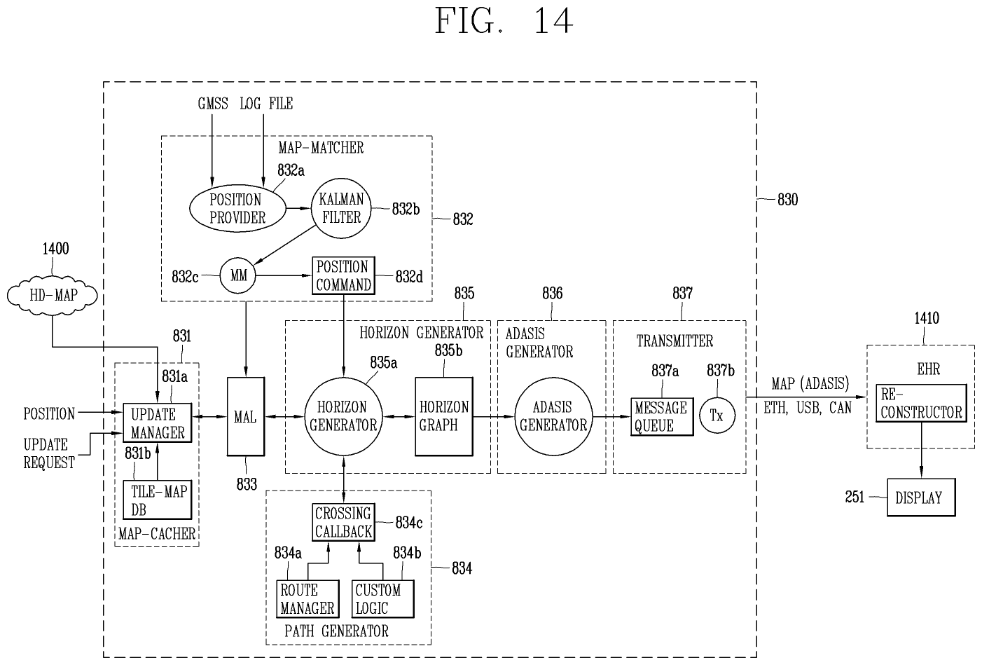

FIG. 14 is a conceptual view of an exemplary processor included in a path providing device.

As described above, the path providing device 800 may provide a path to a vehicle, and may include the telecommunication control unit 810, the interface unit 820, and the processor 830 (EHP).

The telecommunication control unit 810 may receive map information composed of a plurality of layers of data from a server. At this time, the processor 830 may receive map information (HD map tiles) formed in units of tiles through the telecommunication control unit 810.

The interface unit 820 may receive sensing information from one or more sensors provided in the vehicle.

The processor 830 may include (may be provided with) eHorizon software described herein. As a result, the path providing device 800 may be an EHP (Electronic Horizon Provider).

The processor 830 may identify any one lane in which the vehicle is located on a road composed of a plurality of lanes based on an image received from an image sensor among the sensing information.

Furthermore, the processor 830 may estimate an optimal path that is expected or planned to move the vehicle 100 based on the identified lane in units of lanes using the map information.

The processor 830 may generate field-of-view information for autonomous driving in which sensing information is merged with the optimal path to transmit it to at least one of electrical parts provided in the server and the vehicle.

Since the field-of-view information for autonomous driving merged with the optimal path and sensing information is based on an HD map, it may be composed of a plurality of layers, and the description of FIGS. 11A and 11B will be analogically applied to each layer in the same or similar manner.

Dynamic information for guiding a movable object located on the optimal path may be merged into the field-of-view information for autonomous driving.

The processor 830 may update the optimal path based on the dynamic information.

The processor 830 may include a map cacher 831, a map matcher 832, map-dependent APIs (MAL) 833, a path generator 834, a horizon generator 835, an ADASIS generator 836, and a transmitter 837.

The map cacher 831 may store and update map information (HD map data, HD map tiles, etc.) received from the server (cloud server, external server) 1400.

The map matcher 832 may map a current location of the vehicle to the map information.

The map-dependent API (MAL) 833 may convert map information received from the map cacher 831 and information that maps the current location of the vehicle to the map information in the map matcher 832 into a data format that can be used by the horizon generator 835.

Furthermore, the map-dependent API (MAL) 833 may transfer or operate an algorithm to transfer map information received from the map cacher 831 and information that maps the current location of the vehicle to the map information in the map matcher 832 to the horizon generator 835.

The path generator 834 may provide road information on which the vehicle can drive from the map information. In addition, the path generator 834 may receive road information that can be driven from AVN, and provide information required for generating a path (optimal path or sub path) on which the vehicle can drive to the horizon generator 835.

The horizon generator 835 may generate a plurality of path information that can be driven based on the current location of the vehicle and the road information that can be driven.

The ADASIS generator 836 may convert the plurality of path information generated by the horizon generator 835 into a message form to generate an ADASIS message.

In addition, the transmitter 837 may transmit the ADASIS message generated in the form of a message to an electrical part provided in the vehicle.

Hereinafter, each component will be described in more detail.

The map cacher 831 may request tile-based map information (HD map tiles required for the vehicle) among a plurality of tile-based map information (a plurality of HD map tiles) existing in the server 1400.

Furthermore, the map cacher 831 may store (or temporarily store) tile-based map information (HD map tiles) received from the server 1400.

The map cacher 831 may include an update management module 831a (update manager) that requests and receives at least one map information among the plurality of tile-based map information existing in the server 1400 based on a preset condition being satisfied and a cache memory 831b (tile-map DB) that stores the tile-based map information received from the server 1400.

The cache memory 831b may also be referred to as a tile map storage.

The preset condition may refer to a condition for requesting and receiving tile-based map information required for the vehicle from the path providing device (specifically, the map cacher 831) to the server 1400.

The preset condition may include at least one of a case where update for tile-based map information is required in an area where the vehicle is currently present, a case where tile-based map information in a specific area is requested from an external device, or a case where its tile unit size is changed.

For example, the map cacher 831 included in the processor 830 may request and receive tile-based map information in which the vehicle is currently located, tile-based map information in a specific area requested from an external device or tile-based map information whose tile unit size is changed to and from the server based on the preset condition being satisfied.

When new tile-based map information is received from the server 1400, the update management module 831a may delete the existing map information in an area indicated by (included in) the received map information and tile-based map information for an area in which has passed by driving the vehicle from the cache memory 831b.

The map matcher 832 may include a position providing module 832a (position provider) that extracts data indicating the current location of the vehicle from any one of a signal received from a satellite (GNSS (Global Navigation Satellite System) signal (e.g., a signal indicating the current location of the vehicle received from a satellite), a driving history, and a component provided in the vehicle, a filter 832b (Kalman filter) that filters the data extracted from the position provider to generate location information indicating the current location of the vehicle), and a map matching module 832c (MM) that maps location information indicating the current location of the vehicle onto tile-based map information stored in the map cacher, and performs position control so that the current location of the vehicle is located at the center of the display module.

Here, performing position control so that the current location of the vehicle is located at the center of the display module may include the meaning of mapping map information received through the server 1400 based on the current location of the vehicle.

The map matching module 832c may request the map cacher 831 to receive tile-based map information for mapping the location information from the server when the tile-based map information for mapping the location information does not exist in the map cacher 831.

In this case, the map cacher 831 may request and receive the tile-based map information (HD map tiles) requested from the map matching module 832c to the server 1400 in response to the request to transmit the map information to the map matcher (or map matching module 832c).

In addition, the map matching module 832c may generate location information indicating the current location of the vehicle with a position command 832d and transmit it to the horizon generator 835. The position command may be used to generate horizon information based on the current location of the vehicle when the horizon information is generated by the horizon generator.

The map-dependent API (MAL) 833 may convert map information (tile-based map information, HD map tiles) received from the map cacher 831 and information that maps the current location of the vehicle to the map information in the map matcher 832 into a data format that can be used by the horizon generator 835.

The path generator 834 may extract road information on which the vehicle can drive from the received tile-based map information (HD map tiles), and provide the extracted road information to the horizon generator so as to calculate an optimal path and a sub path expected to be driven by the vehicle.

In other words, the received map information may include various types of roads, for example, a roadway through which vehicles can pass, a road through which vehicles cannot pass (e.g., a pedestrian road, a bicycle road, and a narrow road).

The path generator 834 may extract road information on which a vehicle can drive among various types of roads included in the map information. At this time, the road information may also include direction information for a one-way road.

Specifically, the path generator 834 may include a road management module 834a (route manager) that assigns a score to path information required for driving from a current location of the vehicle to a destination among road information that can be driven, from tile-based map information (HD map tiles) received from the server 1400, a custom logic module 834b (custom logic) that assigns a score to a road after its next intersection according to the characteristics of the road where the vehicle is currently located, and a crossing callback module 834c (crossing callback (CB)) that provides information reflecting the score assigned by the road management module 834a and the score assigned by the custom logic module 834b to the horizon generator 835.

The crossing callback module 834c may perform path guidance based on the score assigned by the road management module 834a (or transmit road information to which the score is assigned by the road management module to the horizon generator) when the vehicle is located on a path corresponding to path information required to drive to the destination, and perform path guidance based on the score assigned by the custom logic module (or transmit road information to which the score is assigned by the custom logic module to the horizon generator) when the vehicle deviates from a path corresponding to path information required to drive to the destination.

This is to allow the horizon generator 845 to generate an optimal path and field-of-view information for autonomous driving required to drive to a destination based on the road information to which the score is assigned by the road management module when the destination is set.

Furthermore, when a destination is not set or when the vehicle deviates from a path corresponding to path information required to drive to the destination, the horizon generator 835 may generate an optimal path or sub path based on a road to which the score is assigned by the custom logic module 834b, and generate field-of-view information for autonomous driving corresponding to the optimal path and the sub path.

The horizon generator 835 may generate a horizon tree graph with respect to a current location of the vehicle, based on the location of the vehicle mapped to map information by the map matcher 832 and road information that can be driven, processed by the path manager.

For example, the horizontal tree graph may refer to information in which roads generated with field-of-information for autonomous driving are connected to the optimal path and sub path at each interconnection (or each portion separated from a road) from the current location of the vehicle to the destination.

Such information may refer to a horizontal tree graph since it is seen as a tree branch shape by connecting roads generated with field-of-view information for autonomous driving at an intersection.

In addition, field-of-view information for autonomous driving is generated not only for a single path (optimal path) but also for a plurality of paths (an optimal path and a plurality of sub paths) since the field-of-view for autonomous driving is not generated only for an optimal path from the current location of the vehicle to the destination but also for sub paths different from the optimal path (roads corresponding to sub paths other than a road corresponding to the optimal path at an intersection).

Accordingly, the field-of-view information for autonomous driving from the current location of the vehicle to the destination may have a shape in which branches of a tree extend, and accordingly, the field-of-view information for autonomous driving may refer to a horizontal tree graph.

The horizon generator 835 (or horizontal generation module 835a) may set a length of a horizontal tree graph 835b and a width of a tree link, and generate the horizontal tree graph with respect to roads within a predetermined range from a road on which the vehicle is currently located, based on the current location of the vehicle and the tile-based map information.

Here, the width of the tree link may denote a width that generates field-of-view information for autonomous driving (e.g., a width allowed to generate field-of-view information for a sub path only up to a predetermined width (or radius) based on an optimal path).

In addition, the horizon generator 835 may connect roads included in the generated horizontal tree graph in units of lanes.

As described above, the field-of-view information for autonomous driving may calculate an optimal path, sense an event, sense vehicle traffic, or determine dynamic information in units of lanes included in a road, other than in units of roads.

Accordingly, the horizon generator 835 may generate a horizontal tree graph by connecting roads included in the generated horizontal tree graph in units of lanes included in the roads, instead of simply connecting roads to roads included in the generated horizontal tree graph.

Furthermore, the horizon generator 835 may generate different horizontal tree graphs according to a preset generation criterion.

For example, the horizon generator 835 may generate a different optimal path and sub path based on a user input (or a user request), or based on a criterion for generating the optimal path and sub path (e.g., the fastest path to reach the destination, the shortest path, a free path, a high-speed road priority path, etc.), and accordingly, generate different field-of-view information for autonomous driving.

Since differently generating field-of-view information for autonomous driving may denote generating field-of-view information for autonomous driving for a different road, and thus field-of-view information for autonomous driving generated on a different road may eventually denote generating a different horizontal tree graph.

The horizon generator 835 may generate an optimal path and a sub path on which the vehicle is expected to drive based on road information that can be driven, transmitted from the path generator 834.

In addition, the horizon generator may generate or update the optimal path and sub path by merging dynamic information with field-of-view information for autonomous driving.

The ADASIS generator 836 may convert a horizontal tree graph generated by the horizon generator 835 into an ADASIS message to have a predetermined message form.

As described above, in order to effectively transmit eHorizon (electronic Horizon) data to autonomous driving systems and infotainment systems, the EU OEM (European Union Original Equipment Manufacturing) Association has established a data specification and transmission method as a standard under the name “ADASIS (ADAS (Advanced Driver Assist System) Interface Specification).”

Accordingly, the EHP (the processor 830 of the path providing device) of the present disclosure may include an ADASIS generator 836 that converts a horizontal tree graph (i.e., field-of-view information for autonomous driving or an optimal path and an sub path) into a predetermined message form (e.g., a message form in a format conforming to the standard).

The ADASIS message may correspond to the field-of-view information for autonomous driving. In other words, since a horizontal tree graph corresponding to field-of-view information for autonomous driving is converted into a message form, the ADASIS message may correspond to the field-of-view information for autonomous driving.

The transmitter 837 (transmitter) may include a message queue module 837a that transmits an ADASIS message to at least one of electrical parts provided in the vehicle.

The message queue module 837a may transmit the ADASIS message to the at least one of electrical parts provided in the vehicle in a preset scheme (Tx).

Here, the preset scheme may transmit ADASIS messages with a function (Tx) of transmitting messages or a condition of transmitting messages in the order in which the ADASIS messages were generated, first transmit a specific message based on the message content, or preferentially transmit a message requested from an electrical part provided in the vehicle.

Meanwhile, the above-described path providing device 800 has been described as being provided in the vehicle 100, but the present disclosure is not limited thereto.

The path providing device according to an embodiment of the present disclosure may be provided in the server 1400.

Here, the server 1400 may mean a cloud, a cloud server, the Internet, an external server, or the like. In addition, the server may include all types of external devices capable of transmitting and receiving data to and from the vehicle.

The path providing device 800 of the present disclosure may be provided in the server 1400 instead of in the vehicle 100. In this case, the path providing device 800 may receive various information from the vehicle 100. Then, the path providing device 800 may generate an optimal path on which the relevant vehicle 100 must drive or field-of-view information for autonomous driving, based on the information received from the vehicle 100.

Then, the path providing device 800 may transmit the optimal path or field-of-view information for autonomous driving to the relevant vehicle 100.

As described above, when the path providing device 800 is provided on the server side, in the present disclosure, the server may collect information from the vehicle, and the server may transmit at least one of an optimal path in units of lanes and field-of-view information for autonomous driving that is used during autonomous driving to the vehicle, based on the collected information.

As described above, the path providing device 800 being provided in the server may include a meaning of the EHP being provided in the server.

Furthermore, when the EHP is provided in the cloud server, in the present disclosure, it may be referred to as the term EHC (Electronic Horizon Cloud).

In other words, the EHC (Electronic Horizon Cloud) may denote that the vehicle is provided in a cloud with an EHP for generating field-of-view information for autonomous driving required during autonomous driving or generating an optimal path in units of lanes.

Hereinafter, in case where the path providing device 800 of the present disclosure including an EHP (processor 830) is provided in a server, a method of controlling the path providing device will be described in more detail with reference to the accompanying drawings.

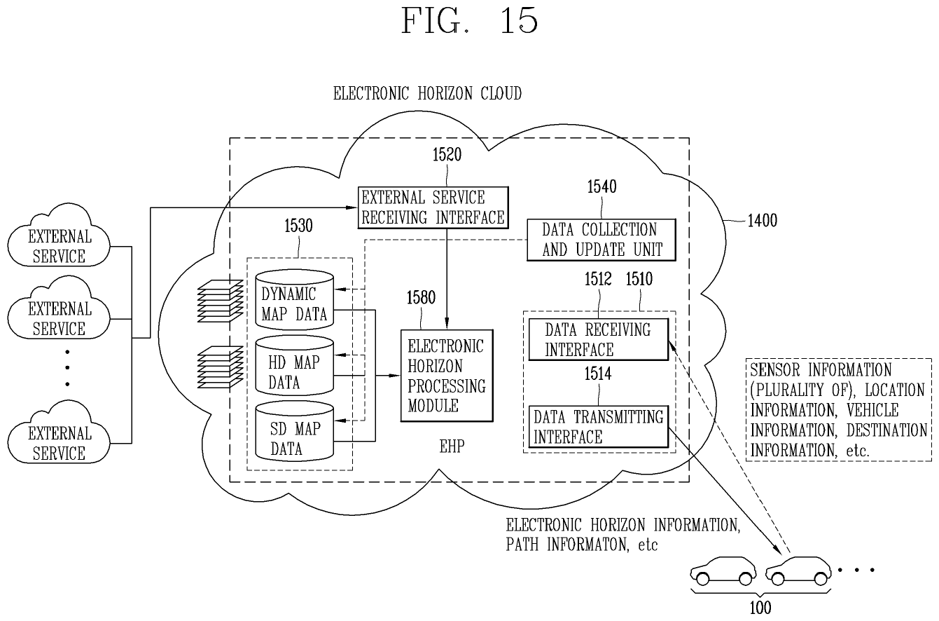

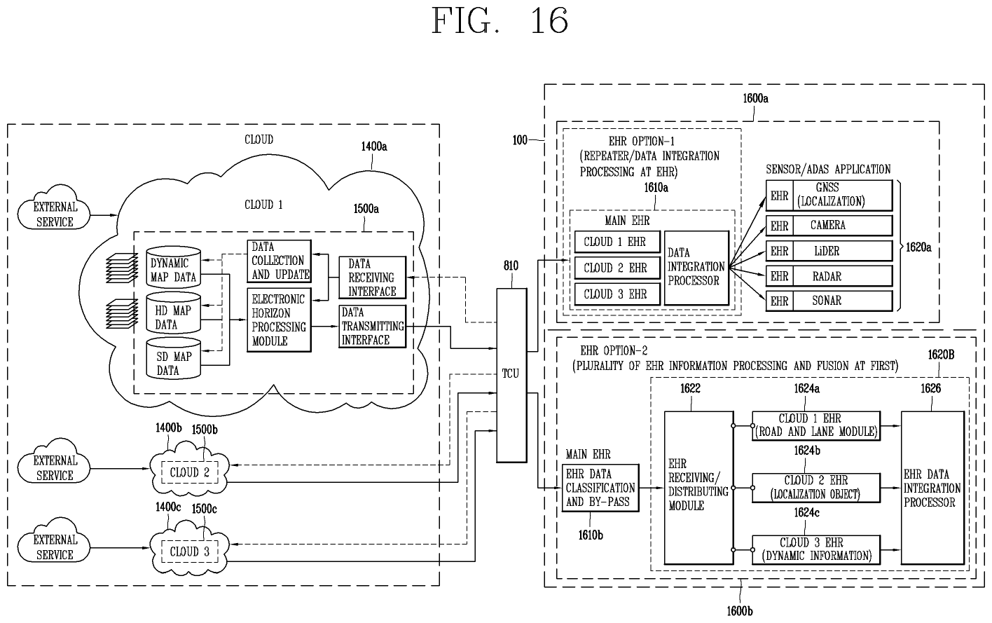

FIG. 15 is a conceptual view of an exemplary path providing device provided in a server, and FIG. 16 is a conceptual view of an exemplary implementations of a vehicle for receiving information from a path providing device provided in a server.

Referring to FIG. 15, a path providing device 1500 provided in a server 1400 may include a telecommunication control unit 1510, an interface unit 1520, a storage unit 1530, a data collection and update unit 1540, and a processor (EHP module) 1580.

The telecommunication control unit 1510 may include a data receiver 1512 (or data receiving interface) that receives information transmitted from the vehicle and a data transmitter 1514 (or data transmitting interface) that transmits information generated by the processor 1580 to the vehicle.

The interface unit 1520 may perform the role of receiving an external service. For example, the interface unit 1520 may perform the role of receiving information related to external services from another server providing the external services.

The external services may include, for example, various services such as a service that provides map information, a service that informs real-time traffic conditions, and a service that informs weather.

The interface unit 1520 may receive information related to an external service from a server that provides such external services. The role performed by the interface unit 1520 may be performed by the telecommunication control unit 1510.

The storage unit 1530 may store data required for generating an optimal path or field-of-view information for autonomous driving from the path providing device 1500 provided in the server 1400.

For example, at least one of a plurality of map information and dynamic information for guiding a movable object may be stored in the storage unit 1530.

The plurality of map information may include map information generated by different map companies, SD map information, HD map information (high-definition map information), tile-based map information, and the like.

The EHP module (hereinafter, referred to as a processor) 1580 may generate an optimal path and field-of-view information for autonomous driving using at least one of information received through the telecommunication control unit 1510 (data receiver 1512), information received through the interface unit 1520, or information stored in the storage unit 1530.

Furthermore, the processor 1580 may update map information and dynamic information stored in the storage unit 1530 using information received from the vehicle 100 through the data receiver 1512.

In addition, the processor 1580 may generate at least one of an optimal path in units of lanes to be transmitted to a target vehicle and field-of-view information for autonomous driving in which sensing information is merged with the optimal path using map information and dynamic information.

One of the information received from the vehicle may include sensing information sensed through sensors provided in the vehicle. Furthermore, the path providing device 1500 provided in the server 1400 may receive sensing information from one or more vehicles.

The processor 1580 of the path providing device 1500 provided in the server 1400 may receive sensing information from at least one or more vehicles, and reflect the received sensing information on the map information and optimal path to generate field-of-view information for autonomous driving.

In addition, the processor 1580 may control the telecommunication control unit 1510 (specifically, the data transmitter 1514) to transmit at least one of the generated optimal path and field-of-view information for autonomous driving to the target vehicle.

In summary, the path providing device 1500 provided in the server 1400 (cloud server) may store at least one of SD map information, HD map information, and dynamic information in the storage unit 1530.

The data receiver 1512 of the path providing device 1500 may receive information transmitted from the vehicle 100. For example, the information transmitted from the vehicle may include information (e.g., sensor information) sensed through sensors (or sensing modules) provided in the vehicle, location information (e.g., location information sensed through the communication device provided in the vehicle), vehicle information (e.g., a mode in which the vehicle is driving, a speed of the vehicle, a weight of passengers on board the vehicle, which parts of the vehicle are being driven, etc.), destination information, and the like.

The processor 1580 may update at least one of map information or dynamic information using the received information.

Furthermore, the processor 1580 may generate at least one of an optimal path in units of lanes to be transmitted to a target vehicle or field-of-view information for autonomous driving in which sensing information is merged with the optimal path using at least one of map information or dynamic information.

In addition, the data transmitter 1514 may transmit at least one of the optimal path or field-of-view information for autonomous driving generated by the processor 1580 to the target vehicle under the control of the processor 1580.

The target vehicle may include a vehicle in communication with the server 1400, a vehicle that transmits information to the path providing device 1500 provided in the server 1400, and a vehicle capable of receiving information from the path providing device 1500 provided in the server 1400, a vehicle that has requested at least one of an optimal path and field-of-view information for autonomous driving to the path providing device 1500 provided in the server 1400, and the like.

The processor 1580 may be an EHP module capable of performing the foregoing functions of the EHP. The processor 1580 may fabricate and process data using information collected through a data receiver, information collected through an external service receiving interface, map information and dynamic information stored in advance, and the like.

Fabricating and processing data may include a process of generating/updating an optimal path or field-of-view information for autonomous driving requested by the target vehicle, or updating map information and dynamic information.

As illustrated in FIG. 15, the electronic horizon information may include the above-described field-of-view information for autonomous driving, an optimal path, and the like.

In some implementations, referring to FIG. 16, a plurality of path providing devices may be provided in a cloud server.

For example, as illustrated in FIG. 16, a cloud may be provided with a plurality of servers 1400a, 1400b, and 1400c, and each server may be provided with a respective path providing device 1500a, as described with respect to FIG. 15.

In some implementations, as illustrated in FIG. 15, a plurality of servers 1400 may be provided with the path providing device 1500. The plurality of servers 1400a, 1400b, and 1400c may refer to servers operated by different companies/entities (subjects) or servers installed in different locations.

As described above, an optimal path or field-of-view information for autonomous driving generated by the path providing device provided in the at least one server 1400a, 1400b, or 1400c, respectively, may be transmitted to the vehicle 100 through the telecommunication control unit 810 (TCU).

At this time, since the server is provided with an electronic horizon provider (EHP) that generates an optimal path or field-of-view information for autonomous driving, the vehicle 100 may be provided with an electronic horizon reconstructor (or receiver) (EHR) for receiving it.

At this time, the EHR provided in the vehicle 100 may be configured in different forms, as illustrated in FIG. 16.

For example, an EHR 1600a of the vehicle 100 may include EHRs for receiving information transmitted from a plurality of servers (Cloud 1, Cloud 2, Cloud 3) and a data integration processor for collectively processing data in the main EHR 1610a.

The EHR 1600a of the vehicle 100 may receive information from a plurality of servers 1400a, 1400b, 1400c through the telecommunication control unit (TCU) to store information transmitted from each server in an EHR corresponding the each server provided in the main EHR 1600a.

Then, the data integration processor provided in the main EHR 1600a may transmit the received information (e.g., an optimal path or field-of-view information for autonomous driving) to sensors or applications 1620a provided in the vehicle.

Each sensor and application 1620a may be provided with an EHR for receiving information transmitted from the main EHR.

The EHR 1600b of the vehicle 100 may be provided with a main EHR 1610b formed to directly transmit data to a sensor or application 1620b without processing data.

The main EHR 1610b may directly transmit information received from a plurality of servers to an EHP receiving/distributing module 1622 provided in the sensor or application 1620b with no additional classification.

The sensor or application 1620b may classify information transmitted for each server by the EHP receiving/distributing module 1622, respectively (Cloud 1 EHR, Cloud 2 EHR, Cloud 3 EHR). Then, the information classified and stored for each server may be processed in the EHR data integration processor 1626, and the processed information may be transmitted to the sensor or application to be used in the sensor or application.

In summary, the cloud server-based electronic horizon system may include an electronic horizon provider (EHP) performed on the server side and an electronic horizon reconstructor (EHR) performed on the client side (vehicle side).

The path providing devices 1500a, 1500b, 1500c provided in the cloud servers 1400a, 1400b, 1400c, as shown in FIG. 15, may have maps (SD/HD) and dynamic information to receive information (sensor information, location information, destination information, etc.) provided by the vehicle.

In addition, the path providing devices 1500a, 1500b, 1500c provided in the servers 1400a, 1400b, 1400c may collect information provided by the vehicle 100, update map information and dynamic information, and fabricate and process them to generate an optimal path or field-of-view information for autonomous driving.

Then, the path providing devices 1500a, 1500b, 1500c provided in the servers 1400a, 1400b, 1400c may transmit the generated the generated optimal path or field-of-view information for autonomous driving to the target vehicle that has requested the relevant information.

In some implementations, in the vehicle 100, when there exists EHP information provided by a plurality of cloud servers, the vehicle may include an EHR capable of selectively receiving necessary information. For example, the EHP information may include all types of information generated/processed/fabricated in the EHP, such as an optimal path, field-of-view information for autonomous driving, map information, and dynamic information.

For example, the vehicle communication module (TCU) (telecommunication control unit) 810 may selectively receive EHP information provided by the plurality of cloud servers 1400a, 1400b, and 1400c.

The main EHR 1610a may classify EHP information received from each cloud server by providers (service providers, or server subjects (companies)), and reconstruct it into information required for vehicle sensors.

The in-vehicle sensors 1620a may receive information transmitted from the main HER 1610a and use the information for sensor fusion. Here, the sensor fusion may refer to a concept including merging the received information with information sensed by the sensor, operating the sensor using the received information, controlling the sensor to perform an operation corresponding to the received information, and the like.

The EHP information provided by each cloud server 1400a, 1400b, 1400c may have advantages according to the characteristics of data possessed by the relevant provider (server) or the path generation algorithm. Accordingly, the EHR of the vehicle may selectively receive to process/integrate the information.

The EHR performed in the vehicle may be configured in two forms, such as a structure 1600a that processes EHP information received from a server to transmit the information to a sensor, and a structure 1600b that by-passes EHP information to a sensor without data processing.

As described above, when the path providing device is provided in a server (cloud, cloud server), it may be possible to perform different control from a case where the path providing device is provided in the vehicle.

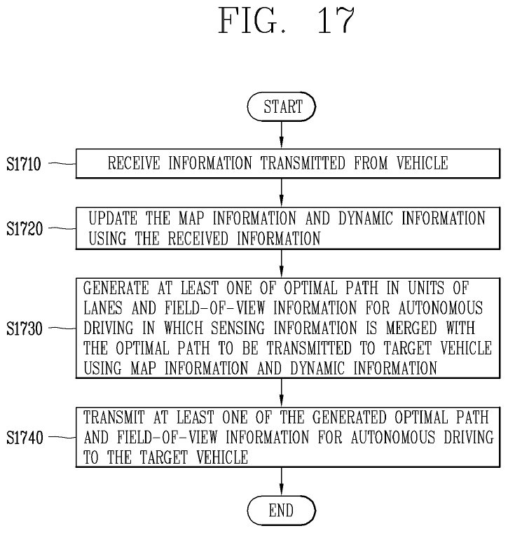

FIG. 17 is a flowchart of an exemplary control method.

As described above, the path providing device 1500 provided in the server 1400 may receive information transmitted from the vehicle 100 (S1710).

The EHP (processor 1580) provided in the path providing device 1500 may update map information and dynamic information using the received information (S1720).

In addition, the processor 1580 may generate at least one of an optimal path in units of lanes to be transmitted to a target vehicle and field-of-view information for autonomous driving in which sensing information is merged with the optimal path using map information and dynamic information (S1730).

For example, according to a request from the target vehicle, the processor 1580 may generate only an optimal path, generate only field-of-view information for autonomous driving, or generate both.

Then, the processor 1580 may transmit at least one of the generated optimal path or field-of-view information for autonomous driving to the target vehicle (S1740).

Hereinafter, information including at least one of the optimal path or field-of-view information for autonomous driving will be referred to as EHP information.

For example, in the present specification, transmitting EHP information to the vehicle by the path providing device 1500 provided in the server 1400 may denote transmitting at least one of the optimal path configured in units of lanes or the field-of-view information for autonomous driving including the optimal path to the vehicle.

The autonomous driving horizon information, as information (or data, environment) used by the vehicle 100 to perform autonomous driving in units of lanes, may denote environmental data for autonomous driving in which all information (map information, vehicles, things, moving objects, environment, weather, etc.) within a predetermined range are merged based on a road or an optimal path including a path in which the vehicle 100 moves. The environmental data for autonomous driving may denote data (or a comprehensive data environment), based on which the processor 830 of the path providing device 800 allows the vehicle 100 to perform autonomous driving or calculates an optimal path of the vehicle 100.

For the field-of-view information for autonomous driving, sensing information may be merged into an optimal path, and may be updated by dynamic information and sensing information.

The target vehicle described in the present specification may include a vehicle that requests at least one of the optimal path and field-of-view information for autonomous driving (i.e., EHP information) to the path providing device provided in the server, or a vehicle subject to transmission when the path providing device transmits EHP information from the server side to the vehicle side.

In other words, the target vehicle may include all types of vehicles capable of communicating with the path providing device provided in the server according to the present disclosure.

When a navigation system of the related art and an EHP of the present disclosure exist in a server, there are some similar parts in that the server generates and transmits a path on which the vehicle drives, but there are differences in a method of configuring and transmitting data.

Specifically, in a case of the navigation system in conventional systems, entire path information is collectively transmitted.

The navigation system in the conventional systems collectively generates and transmits the entire path information to be driven by the vehicle to the vehicle, based on the current location and destination information of the vehicle.

In addition, when the vehicle drives on a path different from the relevant path information, the entire path to the destination is generated and transmitted again to the vehicle based on the location of the vehicle deviated to the different path.

On the other hand, the path providing device (EHP) may sequentially transmit EHP information corresponding to a predetermined distance in front of the vehicle in a streaming manner (or in real time).

Furthermore, the path providing device (EHP) may generate and transmit EHP information (an optimal path, or field-of-view information for autonomous driving) corresponding to a predetermined distance in front of the vehicle in units of lanes.

In addition, the path providing device (EHP) may generate and transmit EHP information (an optimal path (MPP), a sub path, etc.) corresponding to a predetermined distance based on the current location of the target vehicle in real time.

For example, the path providing device (EHP) may generate/update EHP information within a predetermined distance based on the current location of the target vehicle to provide the information to the vehicle in real time, in a different manner from the navigation system in the conventional systems that provides an entire path to the destination so as to perform optimal path provision by reflecting events, traffic information, weather information, and the like that occur in real time.

In the case of the conventional navigation system, a path from the origin to the destination is generated based on the SD map, and only guide information (turn-by-turn information) at intersections is generated, and an entire path is merely transmitted in a batch.

On the contrary, in the case of the path providing device (EHP), it is distinguished from a navigation system in the conventional systems in that an optimal path (Most Prefer Path, MPP) and a sub path are generated units of lanes, in that location information for each object affecting driving (Localization Object information) is provided, in that EHP information corresponding to a predetermined distance in front of the current location is transmitted, and additional EHP is continuously generated and transmitted in real time according to the driving of the vehicle, in that EHP information for vehicle sensors (ADAS, safety purpose) and EHP information for autonomous driving (AD, safety purpose) can be used as information, and in that the received EHP information is filtered to suit a plurality of sensors in the vehicle, and used as an input for sensor fusion, and the like.

For example, the path providing device provided in the repeater may perform a different function than when the path providing device is provided in the vehicle or server, as it is provided in the repeater other than the vehicle and the server.

Hereinafter, a function that can be performed when the path providing device is provided in the repeater will be described in more detail with reference to the accompanying drawings.

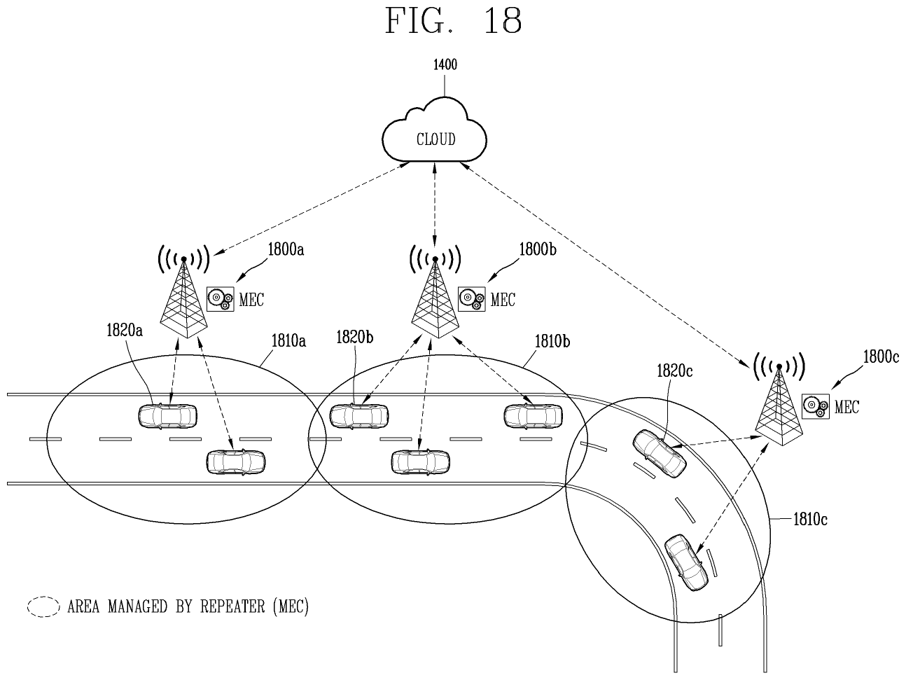

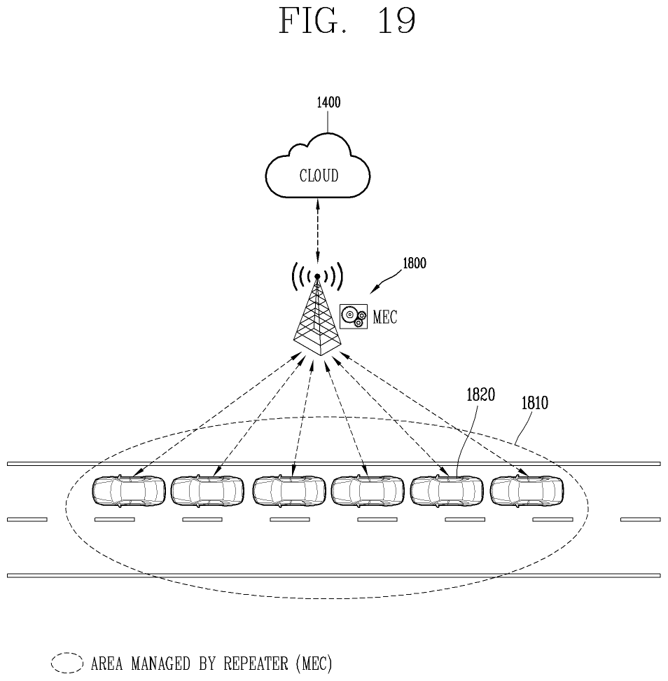

FIGS. 18 and 19 are conceptual views of an exemplary path providing device provided in a repeater.

As described above, the path providing device may be provided in a repeater other than a vehicle or a server.

Referring to FIG. 18, the repeaters 1800a, 1800b, 1800c may refer to a device that serves to relay communication between the server 1400 and the vehicle 100 (or target vehicle 1820a, 1820b, 1820c).

The repeater may include, for an example, an infrastructure installed around the road, a repeater of a communication company providing communication services, a repeater allocated to perform communication by region, and the like.

For example, the repeater may provide a communication service for a specific region, and may serve to efficiently control communication between a server and a vehicle.

MEC (Mobile or Multi-access Edge Computing) technology may be applied to the repeater. MEC may denote a technology that deploys various services and caching contents close to user terminals using distributed cloud computing technology in a wireless base station to alleviate congestion in a mobile core network (e.g., a server) and create new local services.

For example, the present disclosure may divide data processing concentrated on a server into a plurality of repeaters, relieve a burden on the server, and enhance a local service by reflecting events for an allocated area in each repeater.

The repeater may be linked (or coupled) to communicate with at least one server 1400, and a plurality of repeaters may be linked (or allocated) to a single server.

For example, the server (or cloud server) 1400 capable of providing at least one of map information and dynamic information may perform communication with at least one (or a plurality of) repeaters 1800a, 1800b, 1800c.

As illustrated in FIG. 18, each repeater may be installed in different regions. In addition, each repeater may have an allocation area to each other.

For example, the first repeater 1800a may be allocated to (in charge of) a first area (or region) 1810a, and the second repeater 1800b may be allocated to a second region 1810b, and the third repeater 1800c may be allocate to a third area 1810c.

Each repeater may communicate with a vehicle being driving in the allocated area.

For example, the first repeater 1800a may perform communication with a vehicle 1820a driving in the first area 1810a allocated to the first repeater 1800a, and the second repeater 1800b, and the second repeater 1800b may perform communication with a vehicle 1820b driving in the second area 1810b allocated to the second repeater 1800b.

Furthermore, the third repeater 1800c may perform communication with a vehicle 1820c driving in the third area 1810b allocated to the third repeater 1800c.

As illustrated in FIG. 18, each repeater 1800a, 1800b, 1800c may be allocate to (in charge of) different areas 1810a, 1810b, 1810c to perform communication with vehicles 1820a, 1820b, 1820c driving in the allocated areas.

For example, the repeater may receive information (e.g., EHP information including at least one of an optimal path in units of lanes and field-of-view information for autonomous driving in which sensing information is merged with the optimal path) to be transmitted to a target vehicle from the server 1400, and transmit the information to the target vehicle.

In some implementations, the path providing device may be provided in the repeater. Specifically, the path providing device may be provided in the repeater other than the server or vehicle to help implement MEC technology.

For example, in some implementations, the path providing device may be provided in the repeater, unlike cloud computing in which the central server 1400 processes all data, to process data at an edge of the vehicle (i.e., repeater). For this reason, even though the amount of data is large, EHP information may be received through a repeater having a close communication distance with the vehicle, thereby facilitating real-time processing and improving security.

Hereinafter, a function in the case where the path providing device is provided in the repeater will be described in more detail.

Referring to FIG. 19, the exemplary path providing device may be provided in the repeater 1800.

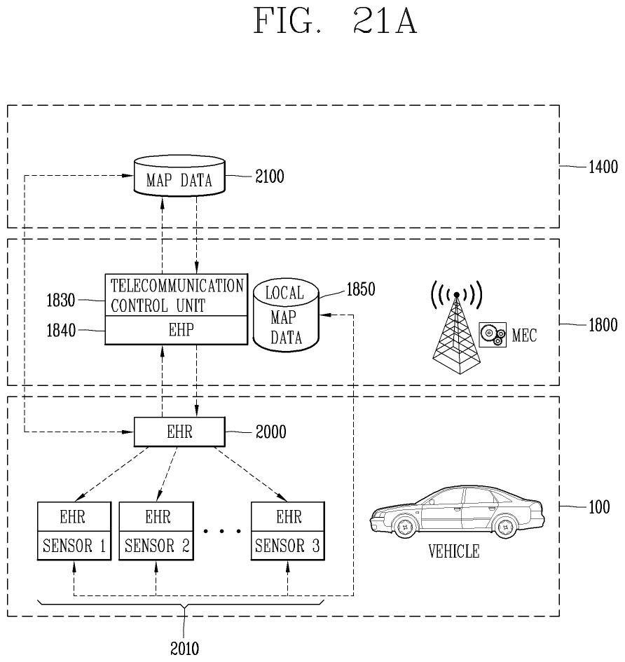

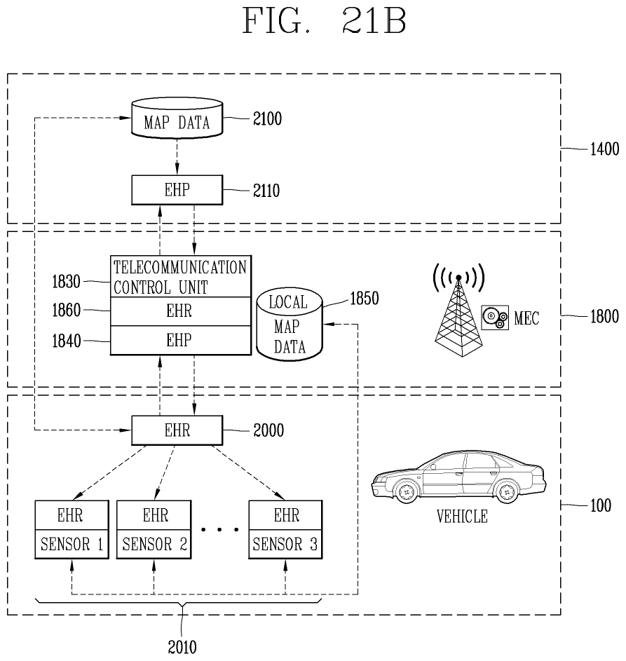

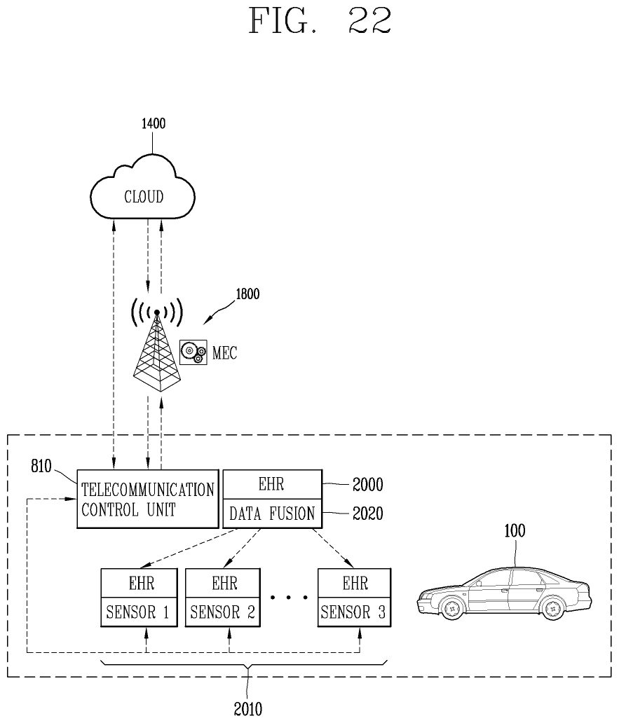

The path providing device provided in the repeater 1800 may include a telecommunication control unit 1830 (refer to FIG. 21A) that performs communication with at least one of the server 1400 and the vehicle 1820 or 100.

In addition, the path providing device may include a processor 1840 (refer to FIG. 21A) that controls the telecommunication control device to receive map information formed from a plurality of layers of data from the server 1400, and receive dynamic information including sensing information from the vehicle 1820 driving in the allocated area 1810.

The processor may generate EHP information including at least one of an optimal path in units of lanes and field-of-view information for autonomous driving in which sensing information is merged with the optimal path to be transmitted to a target vehicle, using map information and dynamic information.

For example, the processor of the path providing device provided in the repeater may be an EHP that generates optimal path in units of lanes and/or field-of-view information for autonomous driving described above.

The processor may receive map information from the server, and receive sensing information or dynamic information including sensing information from at least one vehicle 1820 driving in the allocated area 1810 through the telecommunication control unit.

The dynamic information may include sensing information. As described above, the dynamic information may denote information for guiding a movable object. In other words, the movable object may be understood to include not only the moving object itself, but also all objects that are determined to move relatively according to the driving of the vehicle. Accordingly, the dynamic information may include information on all objects existing around the vehicle. Accordingly, the dynamic information may include sensing information related to an object sensed through a sensor provided in the vehicle.

Subsequently, the processor may generate an optimal path and/or field-of-view information for autonomous driving using map information received from the server and dynamic information received from the vehicle.

At this time, the EHP information including at least one of the optimal path and the field-of-view information for autonomous driving may be EHP information for an area allocated to a repeater.

For example, the path providing device may generate only EHP information for an area allocated by a repeater as it is provided in the repeater.

In some implementations, when a repeater mounted with the path providing device is changed, a target area of the EHP information generated by the path providing device may also be changed according to an allocated area of the mounted repeater.

The processor of the path providing device provided in the repeater 1800 may receive first dynamic information related to the allocated area from at least one vehicle 1820 driving in the allocated area 1810.

Here, the first dynamic information related to the allocated area may include all types of information generated in the allocated area 1810 existing in the allocated area 1810 or generated in the allocated area 1810 such as object (or dynamic object) information existing in the allocated region 1810, event information generated in the allocated region 1810, and traffic information in the allocated region 1810, and driving information of another vehicle, or the like.

In addition, the processor may compare first dynamic information received from the vehicle with second dynamic information included in the map information received from the server 1400 to determine whether it is possible to update the map information provided in the server 1400.

Here, third dynamic information to be compared with the first dynamic information may denote dynamic information included in the map information received from the server 1400 (or dynamic information corresponding to the allocated area 1810 of the dynamic information included in the map information).

For example, the dynamic information may be previously included in the map information, and the second dynamic information to be compared with the first dynamic information received from the vehicle may be dynamic information for an area allocated to the repeater among the dynamic information included in the map information.

When the first dynamic information and the second dynamic information are different from each other, the processor may determine that it is possible to update the map information provided in the server. Furthermore, the processor may upload (transmit) the first dynamic information to the server 1400.

A difference between the first dynamic information and the second dynamic information may denote that the first dynamic information transmitted from the vehicle is more recent information. Accordingly, in order to update the second dynamic information of the map information stored in the server, the repeater 1800 may transmit the first dynamic information on an allocated area received from the vehicle to the server 1400.

The server 1400 that has received the first dynamic information may update the dynamic information for the allocated area of the repeater that has transmitted the information, from the second dynamic information to the first dynamic information.

On the other hand, in order to increase the reliability (accuracy) of the dynamic information for the allocated area of the repeater, the path providing device provided in the repeater may determine the relevant dynamic information as dynamic information (first dynamic information) for the allocated area when the number of the dynamic information having the same content is more than a predetermined number.

Specifically, the processor may receive dynamic information from a plurality of vehicles, respectively, in the allocated area. At this time, the plurality of vehicles may include a vehicle driving in the allocated area.

When the number of dynamic information (i.e., a plurality of dynamic information) having the same content among the received dynamic information is above a predetermined number, the processor may determine dynamic information including the content as first dynamic information.

For example, when ten dynamic information are received from a plurality of vehicles driving in an allocated area, and dynamic information above a predetermined number (e.g., seven) include content that an accident has occurred in the second lane, the processor may determine dynamic information including the content that an accident has occurred in the second lane as first dynamic information (i.e., first dynamic information received from the vehicle).

If dynamic information having the same content among the plurality of dynamic information is less than a predetermined number, the processor may hold the determination of first dynamic information until the number of the dynamic information having the same content is above a predetermined number.

The processor may upload to the server 1400 only the first dynamic information determined based on whether the number of dynamic information having the same content among the received dynamic information (a plurality of dynamic information) is above a predetermined number.

Through such a configuration, the present disclosure may provide a system capable of accurately collecting dynamic information on an area (local area) allocated to a repeater, and reflecting it on a server.

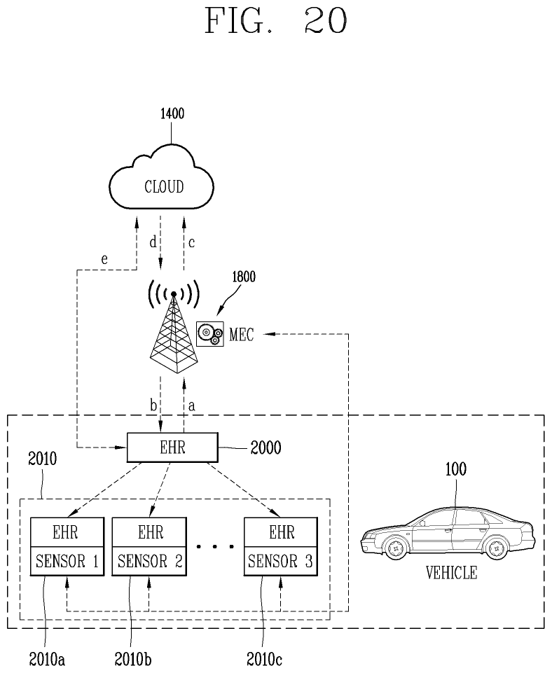

FIGS. 20, 21A and 21B are conceptual views of exemplary implementations of a server, a repeater, and a vehicle when a path providing device is provided in the repeater.

Referring to FIG. 20, the path providing device provided in the repeater 1800 may receive location information of a target vehicle from the target vehicle 100 driving in an allocated area. In addition, the path providing device provided in the repeater 1800 may receive sensing information (or dynamic information including sensing information) sensed by the target vehicle from the target vehicle 100 (a).

For example, the processor of the path providing device provided in the repeater 1800 may receive location information from the target vehicle that has requested EHP information in the allocated area.

Then, the processor may generate EHP information that is usable in the target vehicle based on the received location information and map information received from a server. Then, the processor may transmit the generated EHP information to the target vehicle (b).

Furthermore, the processor may determine dynamic information with a predetermined number or more of dynamic information having the same content among the received dynamic information as meaningful data, and transmit the relevant dynamic information to the server (c).

For example, the dynamic information may include traffic signs, speed limit changes, road signs displayed on the road, and may include event information such as accidents, constructions, and weather.

The server 1400 may update map information by reflecting the dynamic information received from the repeater, and transmit the updated map information to the repeater (d).

On the other hand, the vehicle 100 may receive EHP information directly from the server 1400 instead of the repeater 1800 when a predetermined condition is satisfied (e).

For example, in the vehicle 100 may receive second EHP information from the server instead of the repeater when the first EHP information received from the repeater 1800 is different from the second EHP information transmitted from the server 1400, and map information of the server generating the second EHP information is a more recent version.

By way of further example, the vehicle 100 may receive EHP information directly from the server 1400 when it is required to receive EHP information for a wider range than an area allocated by the repeater or when it leaves an allocated area of the repeater in communication.

The vehicle 100 may include an electronic horizon reconstructor (or receiver) (EHR) that receives EHP information received from the server 1400 or the repeater 1800. Then, the EHR may transfer (distribute, transmit) EHP information received at an electrical part (e.g., one or more sensors or ADAS applications required to perform autonomous driving) 2010 provided in the vehicle.

On the other hand, the EHP information that is usable in a target vehicle may include at least one of an optimal path in units of lanes and field-of-view information for autonomous driving in which sensing information is merged with the optimal path.

The processor may transmit the generated EHP information to a target vehicle, and generates and transmits it in real time whenever the target vehicle drives in the allocated area.

In other words, the path providing device may generate and transmit EHP information from the current location of the vehicle to the destination as a whole, but may provide information in units of lanes and transmit only EHP information for a predetermined distance ahead based on the target vehicle in order to reflect road conditions being changed in real time.

Accordingly, the path providing device may generate and transmit EHP information for a new area in real time whenever the target vehicle drives.

Similarly, when the path providing device is provided in the repeater, the processor may generate and transmit EHP information for the allocated area in real time whenever the target vehicle travels within the allocated area.

In some implementations, when the target vehicle leaves the allocated area, the processor may stop the transmission of EHP information.

The processor may stop the transmission of EHP information when the target vehicle leaves the allocated area, and transmit at least one of EHP information and vehicle information transmitted from the target vehicle to a new repeater allocated to the new area.

For example, the processor may transmit the previously generated EHP information to the new repeater when the target vehicle leaves the allocated area to enter the allocation area of the new repeater.

The new repeater may generate new EHP information in an area allocated by the new repeater by reflecting a path in units of lanes that the target vehicle has driven so far, a driving pattern, and destination information, and the like using the received EHP information, and transmit the new EHP information to the vehicle.

In some implementations, as illustrated in FIG. 21A, the path providing device provided in the repeater may further include a memory 1850 (local map data) for storing partial map information for the allocated area.

The processor may update the partial map information using dynamic information transmitted from the vehicle included in the allocated area.

In addition, the processor may generate the EHP information of the target vehicle driving in the allocated area using the partial map information.

The processor 1840 of the path providing device provided in the repeater 1800 may receive map information from a storage 2100 provided in the server 1400 through the telecommunication control unit 1830, and receive dynamic information including sensing information from the vehicle 100.

On the other hand, for rapid EHP generation in the allocated area and rapid update of dynamic information, the path providing device provided in the repeater 1800 of the present disclosure may store partial map information for the allocated area (or corresponding to the allocated area) in advance in the memory 1850.

Since regions allocated for each repeater are different, partial map information stored in each repeater may be different.

The path providing device provided in the repeater of the present disclosure may generate EHP information using partial map information for the allocated area of the repeater, and update dynamic information to the partial map information, thereby omitting a process of receiving map information and uploading dynamic information from and to the server or significantly reducing the number of times so as to enhance processing speed.

On the other hand, as illustrated in FIG. 21A, unlike the case where the path providing device is provided only on the repeater 1800, the path providing device may be provided in both the server 1400 and the repeater 1800 as illustrated in FIG. 21B.

In this case, the processor 2110 of the path providing device provided in the server 1400 may generate EHP information that is usable in the target vehicle 100 based on map information provided in the storage 2100 of the server 1400, and dynamic information received from the repeater 1800, and the location information of the target vehicle 100.

Then, the server 1400 may directly transmit the generated EHP information to the target vehicle 100 or may transmit it to the repeater 1800.

In order to receive EHP information generated by the server 1400, the path providing device provided in the repeater 1800 may further include an EHR 1860 for receiving EHP information, and changing (converting) information in a form that is usable in the vehicle 100.

In addition, the processor 1840 of the repeater 1800 may update EHP information received through the EHR 1860 by reflecting dynamic information received from the vehicle driving in the allocated area, and transmit the updated EHP information to the target vehicle.

Hereinafter, the configuration of a vehicle that receives EHP information when a path providing device is provided in a repeater will be described in more detail with reference to the accompanying drawings.

FIG. 22 is a conceptual view of an exemplary function of a vehicle capable of receiving EHP information from a server and a repeater.

The path providing device provided in the vehicle that is communicable with at least one of the repeater and the server may include a telecommunication control unit 810 performing communication with the repeater 1800.

Furthermore, the path providing device provided in the vehicle may include a processor 2000 (EHR) that receives EHP information including at least one of an optimal path in units of lanes and field-of-view information for autonomous driving in which sensing information is merged with the optimal path from the repeater 1800 through the telecommunication control unit 810, and distributes the received EHP information to at least one electrical part 2010 provided in the vehicle.

The processor 2000 provided in the vehicle 100 may be an electronic horizon receiver (EHR). In other words, the processor 2000 may receive EHP information generated by the repeater 1800 (or the server 1400), and change (or convert) the information to a form that is usable in the electrical part 2010.

The processor 2000 may output an optimal path in units of lanes or autonomously drive the vehicle using the received EHP information.

To this end, the processor 2000 may transmit the optimal path in units of lanes to a display module provided in the vehicle from the received EHP information and output the optimal path in units of lanes to the display module.

In addition, in order to autonomously drive the vehicle, the processor 2000 may transmit field-of-view information for autonomous driving from the received EHP information to at least one electrical part 2010 (sensor or ADAS application) required to perform autonomous driving.

EHR may also be provided in each electrical part 2010. The EHR provided in each electrical part 2010 may perform the role of converting the form of information to allow EHP information to be used in each electrical part.

For example, the EHR provided in the camera sensor may convert EHP information to be usable in the camera sensor.

In some implementations, the processor 2000 of the path providing device provided in the vehicle may search for a new repeater when it is detected that the vehicle leaves the allocated area of the repeater 1800 in communication.

For example, the processor 2000 may sense (determine) that the vehicle leaves the allocated area of the repeater 1800 in communication based on whether communication with the repeater 1800 in communication stops, the communication speed drops below a predetermined speed, or the vehicle leaves partial map information included in the EHP information received from the repeater 1800.

When a new repeater is searched, the processor 2000 may receive EHP information from the new repeater. In other words, when a new repeater allocated to (in charge of) a new area where the vehicle has entered is searched, the processor 2000 may receive EHP information for the newly entered area while driving the newly entered area from the new repeater.

In some implementations, when a new repeater is not searched, the processor 2000 may request and receive EHP information from the server 1400 through the telecommunication control unit 810.

As described above, the telecommunication control unit 810 provided in the vehicle may perform communication with the server 1400 as well as the repeater 1800.

The processor 2000 of the vehicle 100 may receive first EHP information from the repeater 1800 and the second EHP information from the server 1400 through the telecommunication control unit 810.

For example, the processor 2000 of the vehicle 100 may receive EHP information from the repeater 1800 or the server 1400, or may receive EHP information from both the repeater 1800 and the server 1400.

The processor 2000 may process the first EHP information and the second EHP information in a predetermined manner when the EHP information is received from both the repeater 1800 and the server 1400.

For example, when the first EHP information and the second EHP information are the same, the processor 2000 may receive the first EHP information from the repeater 1800, and stop receiving the second EHP information from the server 1400.

In other words, the processor 2000 of the vehicle 100 may receive EHP information from the repeater 1800 closer to the vehicle 100 when the EHP information received from the server 1400 and the repeater 1800 are the same, and stop receiving data from the server 1400 to reduce server overload (edge computing).

In addition, when the first EHP information and the second EHP information are different, the processor 2000 may transmit different EHP information to an electrical part provided in the vehicle according to the type of the electrical part provided in the vehicle.

For example, when the first EHP information received from the repeater 1800 and the second EHP information received from the server 1400 are different, the processor 2000 may transmit the first EHP information to an electrical part (e.g., sensor) that senses an object (or environment) of the vehicle, and transmit the second EHP information to an ADAS application performing autonomous driving of the vehicle according to the type of electronic part provided in the vehicle.

For example, the processor may transmit first EHP information on which information in a local area is more accurately reflected, to the sensor, and transmit second EHP information generated by the server based on information on a wider range to the destination, to the ADAS application.

Through this, the present disclosure may provide a data processing method of a vehicle that is usable by selecting only information optimized for autonomous driving of the vehicle.

In addition, when the first EHP information and the second EHP information are different, the processor 2000 may autonomously drive the vehicle using at least one of the first EHP information and the second EHP information.

To this end, the processor 2000 of the vehicle 100 may be provided with a data fusion unit 2020. The data fusion unit 2020 may merge or select information required for autonomous driving when the first EHP information received from the repeater 1800 is different from the second EHP information received from the server 1400.

For example, when the first EHP information and the second EHP information are different from each other, the data fusion unit 2020 may use an optimal path included in the first EHP information for the optical path in units of lanes, and select field-of-view information for autonomous driving included in the second EHP information for the field-of-view information for autonomous driving, and transmit them to an electrical part provided in the vehicle.

For another example, when the first EHP information and the second EHP information are different, the data fusion unit 2020 may merge an optimal path included in each EHP information and field-of-view information for autonomous driving, and transmit them to an electrical part provided in the vehicle.

In this case, both an optimal path generated by the server and an optimal path generated by the repeater may be displayed on the display module provided in the vehicle, and either one may be selected by user selection.

Similarly, the vehicle may notify a passenger on board the vehicle that both the field-of-view information for autonomous driving generated by the server and the field-of-view information for autonomous driving generated by the repeater exist, and may select either one by passenger selection.

The vehicle may perform autonomous driving based on at least one of the selected optimal path and field-of-view information for autonomous driving.

The function/operation/control method performed by the data fusion unit 2020 may also be performed by the processor 2000 of the vehicle 100.

The effects of a path providing device and a path providing method thereof according to the present disclosure will be described as follows.

First, the present disclosure may provide a path providing device capable of controlling a vehicle in an optimized manner when the path providing device is provided in a repeater.

Second, the present disclosure may allow a path providing device to be provided in a repeater that relays communication between a server and a vehicle, thereby preventing the server from being overloaded.

Third, the present disclosure may allow a path providing device to be provided in a repeater that relays communication between a server and a vehicle, thereby providing a new path providing method capable of generating EHP information for an area allocated by the repeater in an optimized manner and transmitting it to the vehicle included in the allocated area.

The foregoing present disclosure may be implemented as codes (an application or software) readable by a computer on a medium written by the program. The control method of the above-described autonomous vehicle may be implemented by codes stored in a memory or the like.

The computer-readable media may include all kinds of recording devices in which data readable by a computer system is stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

What is claimed is:

1. A path providing device for a vehicle configured to communicate with a repeater, the path providing device comprising:
a telecommunication control unit configured to perform communication with the repeater; and
a processor configured to:
receive, from the repeater, EHP information comprising at least one of an optimal path providing a direction with respect to one or more lanes or autonomous driving visibility information in which sensing information is merged with the optimal path, and
distribute the received EHP information to at least one electrical part disposed at the vehicle.

2. The path providing device of claim 1, wherein the processor is configured to receive the EHP information generated by the repeater to change the received EHP information into a form that is usable in the at least one electrical part.

3. The path providing device of claim 1, wherein the processor is configured to output an optimal path for guiding the vehicle in a lane among a plurality of lanes of a road or autonomously drive the vehicle based on the received EHP information.

4. The path providing device of claim 1, wherein the processor is configured to search for a new repeater based on the vehicle being sensed to leave an allocated area of the repeater in communication.

5. The path providing device of claim 4, wherein the processor is configured to:
receive, based on the new repeater being searched, receive EHP information from the new repeater, and
receive, based on the new repeater not being searched, EHP information from a server through the telecommunication control unit.

6. The path providing device of claim 1, wherein the telecommunication control unit is configured to perform communication with a server, and
wherein the processor is configured to receive first EHP information from a repeater and second EHP information from a server through the telecommunication control unit.

7. The path providing device of claim 6, wherein the processor is configured to process the first EHP information and the second EHP information in a preset manner.

8. The path providing device of claim 7, wherein the processor is configured to, based on the first EHP information and the second EHP information being the same, receive the first EHP information from the repeater, and stop receiving the second EHP information from the server.

9. The path providing device of claim 7, wherein the processor is configured to transmit different EHP information to an electrical part of the at least one electrical part according to a type of the electrical part based on the first EHP information and the second EHP information being different from each other.

10. The path providing device of claim 9, wherein the processor is configured to autonomously drive the vehicle using at least one of the first EHP information or the second EHP information based on the first EHP information and the second EHP information being different from each other.

11. A method for providing a path information to a vehicle, performed by the vehicle configured to communicate with a repeater, the method comprising:
receiving, from the repeater, EHP information comprising at least one of an optimal path or autonomous driving visibility information in which sensing information is merged with the optimal path; and
distributing the received EHP information to at least one electrical part disposed at the vehicle.

12. The method of claim 11, further comprising receiving the EHP information generated by the repeater to change the received EHP information into a form that is usable in the at least one electrical part.

13. The method of claim 11, further comprising outputting an optimal path for guiding the vehicle in a lane among a plurality of lanes of a road or autonomously drive the vehicle based on the received EHP information.

14. The method of claim 11, further comprising searching for a new repeater based on the vehicle being sensed to leave an allocated area of the repeater in communication.

15. The method of claim 14, further comprising:
receiving, based on the new repeater being searched, receive EHP information from the new repeater; and
receiving, based on the new repeater not being searched, EHP information from a server.

16. The method of claim 11, further comprising receiving first EHP information from a repeater and second EHP information from a server.

17. The method of claim 16, further comprising processing the first EHP information and the second EHP information in a preset manner.

18. The method of claim 17, further comprising, based on the first EHP information and the second EHP information being the same, receiving the first EHP information from the repeater, and stop receiving the second EHP information from the server.

19. The method of claim 17, further comprising transmitting different EHP information to an electrical part of the at least one electrical part according to a type of the electrical part based on the first EHP information and the second EHP information being different from each other.

20. The method of claim 19, further comprising autonomously driving the vehicle using at least one of the first EHP information or the second EHP information based on the first EHP information and the second EHP information being different from each other.
